(19) United States
(12) Patent Application Publication
(10) Pub. No.: US 2023/0368690 A1
(43) Pub. Date: Nov. 16, 2023

(54) MOBILE APPLICATION FOR GENERATING AND VIEWING VIDEO CLIPS IN DIFFERENT LANGUAGES

(71) Applicant: Gemiini Educational Systems, Inc., Spokane, WA (US)

(72) Inventors: Nicholas Alexander Kasbar, Spokane, WA (US); Laura Marie Kasbar, Newport Beach, CA (US)

(21) Appl. No.: 18/197,633

(22) Filed: May 15, 2023

Related U.S. Application Data
(60) Provisional application No. 63/342,506, filed on May 16, 2022.

(51) Int. Cl. G09B 5/06; G09B 7/02; H04N 21/234; H04N 21/433; G06F 40/58

(52) U.S. Cl. CPC G09B 5/065; G09B 7/02; H04N 21/23424; H04N 21/4334; G06F 40/58

(57) ABSTRACT

A system may receive lesson information comprising a plurality of lessons and may receive student information associated with a student. The system may prepare a lesson plan based in part on the lesson information and the student information. The system may present a first lesson of the plurality of lessons to the student. The system may determine, based on an interaction between the student and the first lesson, a student engagement information and may apply the student engagement information as input to a machine learning model, and cause the machine learning model to output a lesson success evaluation. The system may determine a lesson success based on the lesson success evaluation. The system may modify the lesson plan based on the lesson success to generate an adjusted lesson plan. The system may present a second lesson of the plurality of lessons to the student based on the adjusted lesson plan.

### CROSS-REFERENCE TO RELATED APPLICATIONS

This application claims the benefit of U.S. Provisional Patent Application No. 63/342,506, entitled “MOBILE APPLICATION FOR GENERATING AND VIEWING VIDEO CLIPS IN DIFFERENT LANGUAGES” and filed on May 16, 2022, which is hereby incorporated by reference herein in its entirety.

### BACKGROUND

Educational systems may utilize computer applications to instruct a user in communicating in one or more languages. For example, the educational system may use multimedia presentations to instruct the user, including audio, video, and text-based learning material.

### SUMMARY

One aspect of the disclosure provides a method comprising: receiving lesson information comprising a plurality of lessons; receiving student information associated with a student; preparing a lesson plan based in part on the lesson information and the student information; presenting a first lesson of the plurality of lessons to the student; determining, based on an interaction between the student and the first lesson, a student engagement information; applying the student engagement information as input to a machine learning model, where applying the student engagement information to the machine learning model causes the machine learning model to output a lesson success evaluation; determining a lesson success based on the lesson success evaluation; modifying the lesson plan based on the lesson success to generate an adjusted lesson plan; and presenting a second lesson of the plurality of lessons to the student based on the adjusted lesson plan.

The method of the preceding paragraph can include any sub-combination of the following features: where the lesson information further comprises a lesson level associated with a difficulty of the plurality of lessons; where the method further comprises: transmitting a request to record a video to a teacher, receiving the video from the teacher, generating a lesson based in part on the received video to create a new lesson, and adding the new lesson to the plurality of lessons; where the request is transmitted in response to the determination of the lesson success; where the method further comprises: applying the lesson plan as input to a machine learning model, where application of the lesson plan to the machine learning model causes the machine learning model to output first information, comparing the first information to the plurality of lessons, and determining, based on the comparison of the first information to the plurality of lessons, the first information is not contained in the plurality of lessons, where the new lesson comprises the first information; where transmitting a request further comprises: applying a third lesson to the machine learning model, where application of the third lesson to the machine learning model causes the machine learning model to output a lesson completeness, and determining the third lesson is an incomplete lesson based on the lesson completeness; where the method further comprises: applying a third lesson to the machine learning model, where application of the third lesson to the machine learning model causes the machine learning model to output an incorrect lesson element, and determining the third lesson is an incorrect lesson based on the incorrect lesson element, where the incorrect lesson is not suitable for presentation to the student; where the incorrect lesson element is one of a position of a teacher, an extraneous sensory stimuli, or an incorrect information item; and where the method further comprises: presenting to a teacher a prompt, the prompt requesting the teacher record the first lesson, displaying to the teacher one or more instructions, the instructions indicating a set of recommendations for recording a first video segment, receiving, from the teacher, a start indication indicating a request to start recording the first video segment, presenting, to the teacher, a video recording interface comprising a position indicator indicating a head position in a video frame, a body position indicator indicating a body position in the video frame, and instructions, recording the first video segment, receiving from the teacher a stop indication indicating the teacher has completed recording the first video segment, terminating recording the first video segment, presenting to the teacher an editing interface comprising a trim option, the trim option allowing the teacher to edit at least a portion of the first video, receiving from the teacher a completion indication indicating the teacher has completed editing the first video segment, and combining the first video segment with a second video segment where the first video segment and the second video segment are associated with a topic of the first lesson to generate the first lesson.

Another aspect of the disclosure provides a system comprising a memory storing computer-executable instruction. The system further comprises a processor in communication with the memory, where the computer-executable instructions, when executed by the processor, cause the processor to: receive lesson information comprising a plurality of lessons; receive student information associated with a student; prepare a lesson plan based in part on the lesson information and the student information; present a first lesson of the plurality of lessons to the student; determine, based on an interaction between the student and the first lesson, a student engagement information; apply the student engagement information as input to a machine learning model, where applying the student engagement information to the machine learning model causes the machine learning model to output a lesson success evaluation; determine a lesson success based on the lesson success evaluation; modify the lesson plan based on the lesson success to generate an adjusted lesson plan; and present a second lesson of the plurality of lessons to the student based on the adjusted lesson plan.

The system of the preceding paragraph can include any sub-combination of the following features: where the lesson information further comprises a lesson level associated with a difficulty of the plurality of lessons; where the computer-executable instructions, when executed by the processor, further cause the processor to: transmit a request to record a video to a teacher, receive the video from the teacher, generate a lesson based in part on the received video to create a new lesson, and add the new lesson to the plurality of lessons; where the computer-executable instructions, when executed by the processor, further cause the processor to: apply the lesson plan as input to a machine learning model, where application of the lesson plan to the machine learning model causes the machine learning model to output a first information, compare the first information to the plurality of lessons, and determine, based on the comparison of the first information to the plurality of lessons, the first information is not contained in the plurality of lessons, where the new lesson comprises the first information; where the computer-executable instructions, when executed by the processor, further cause the processor to: apply a third lesson to the machine learning model, where application of the third lesson to the machine learning model causes the machine learning model to output a lesson completeness, and determine the third lesson is an incomplete lesson based on the lesson completeness; where the computer-executable instructions, when executed by the processor, further cause the processor to: apply a third lesson to the machine learning model, where application of the third lesson to the machine learning model causes the machine learning model to output an incorrect lesson element, and determine the third lesson is an incorrect lesson based on the incorrect lesson element, where the incorrect lesson is not suitable for presentation to the student; where the computer-executable instructions, when executed by the processor, further cause the processor to: present to a teacher a prompt, the prompt requesting the teacher record the first lesson, display to the teacher one or more instructions, the instructions indicating a set of recommendations for recording a first video segment, receive, from the teacher, a start indication indicating a request to start recording the first video segment, present, to the teacher, a video recording interface comprising a position indicator indicating a head position in a video frame, a body position indicator indicating a body position in the video frame, and instructions, record the first video segment, receive from the teacher a stop indication indicating the teacher has completed recording the first video segment, terminate recording the first video segment, present to the teacher an editing interface comprising a trim option, the trim option allowing the teacher to edit at least a portion of the first video, receive from the teacher a completion indication indicating the teacher has completed editing the first video segment, and combine the first video segment with a second video segment where the first video segment and the second video segment are associated with a topic of the first lesson to generate the first lesson; where the video recording interface further comprises a recording status indicator; and where the instructions comprise one of a script or a pronunciation.

Another aspect of the disclosure provides a non-transitory computer-readable storage medium comprising computer-executable instructions, where the computer-executable instructions, when executed by a computer system, cause the computer system to: receive, at a computing device having a processor and a memory, lesson information comprising a plurality of lessons; receive, at the computing device, student information associated with a student; prepare a lesson plan based in part on the lesson information and the student information; present, by a display of the computing device, a first lesson of the plurality of lessons to the student; determine, based on an interaction between the student and the first lesson, a student engagement information; apply the student engagement information as input to a machine learning model, where applying the student engagement information to the machine learning model causes the machine learning model to output a lesson success evaluation; determine a lesson success based on the lesson success evaluation; modify the lesson plan based on the lesson success to generate an adjusted lesson plan; and present, by the display of the computing device, a second lesson of the plurality of lessons to the student based on the adjusted lesson plan.

The non-transitory computer-readable storage medium of the preceding paragraph can include any sub-combination of the following features: where the computer-executable instructions, when executed, further cause the computer system to: transmit a request to record a video to a teacher, present to a teacher a prompt, the prompt requesting the teacher record the first lesson, display to the teacher one or more instructions, the instructions indicating a set of recommendations for recording a first video segment, receive, from the teacher, a start indication indicating a request to start recording the first video segment, present, to the teacher, a video recording interface comprising a position indicator indicating a head position in a video frame, a body position indicator indicating a body position in the video frame, and instructions, record the first video segment, receive from the teacher a stop indication indicating the teacher has completed recording the first video segment, terminate recording the first video segment, present to the teacher an editing interface comprising a trim option, the trim option allowing the teacher to edit at least a portion of the first video, receive from the teacher a completion indication indicating the teacher has completed editing the first video segment, and combine the first video segment with a second video segment where the first video segment and the second video segment are associated with a topic of the first lesson to generate the first lesson.

### BRIEF DESCRIPTION OF THE DRAWINGS

Embodiments of various inventive features will now be described with reference to the following drawings. Throughout the drawings, reference numbers may be re-used to indicate correspondence between referenced elements. The drawings are provided to illustrate example embodiments described herein and are not intended to limit the scope of the disclosure. To easily identify the discussion of any particular element or act, the most significant digit(s) in a reference number typically refers to the figure number in which that element is first introduced.

FIG. 1A depicts a user interface in which the language pyramid tab is selected that allows a teacher, parent, or other like individual to view which video clips at a particular level that have been mastered by a user and/or a number of videos left to translate into the selected translation language.

FIGS. 1B-1C depict additional information that is viewable when the user scrolls down.

FIG. 2A depicts an example user interface in which the language pyramid tab is selected that allows a teacher, parent, or other like individual to view which video clips at a particular level that have been mastered by a user and/or a number of videos left to translate into the selected translation language.

FIGS. 2B-2C depict additional information that is viewable when the user scrolls down.

FIG. 3A depicts an example user interface in which the expressive lessons tab is selected that allows a teacher, parent, or other like individual to view which video clips at a particular level that have been mastered by a user and/or a number of videos left to translate into the selected translation language.

FIG. 3B depicts additional information that is viewable when the user scrolls down.

FIG. 4 depicts an example user interface in which the my playlist tab is selected that allows a teacher, parent, or other like individual to view a list of video clips added to a user's playlist.

FIG. 5 depicts an example user interface that allows a teacher, parent, or other like individual to set one or more sliders for conducting a receptive test.

FIG. 6 depicts an example user interface that provides instructions for running an expressive test.

FIGS. 7-8 depict example user interfaces that provides instructions for running a manual test.

FIG. 9A depicts an example user interface in which the language pyramid tab is selected that allows a teacher, parent, or other like individual to view which video clips at a particular level that have been mastered by a user.

FIGS. 9B-9D depict additional information that is viewable when the user scrolls down.

FIG. 10 depicts an example user interface in which the language pyramid tab is selected that allows a teacher, parent, or other like individual to view a list of video clips at a particular level.

FIG. 11 depicts an example user interface for adding a video clip to a playlist.

FIG. 12 depicts an example user interface for creating a new playlist.

FIG. 13 depicts an example user interface that depicts a list of video segments captured by a teacher, parent, or other like individual.

FIGS. 14-15 depict example log in screens to access a user account.

FIGS. 16-17 depict example user interfaces for selecting a viewing language.

FIGS. 18-19 depict example user interfaces for selecting a translation language.

FIGS. 20-25 depict example user interfaces that provide an introduction and tutorial for using the mobile application.

FIGS. 26-28 depict example user interfaces for configuring profile and application settings.

FIGS. 29-35 depict example user interfaces for gathering biographical characteristics of a user and estimating a level of the user.

FIGS. 36-40 depict example user interfaces that provide instructions to a teacher, parent, or other like individual for capturing one or more video segments.

FIG. 41 depicts an example user interface that may be displayed when a teacher, parent, or other like individual is attempting to capture the first video segment, which can include an outline for a head position and/or an outline for a shoulders position.

FIG. 42 depicts an example user interface that indicates a number of different types of video segments that have been completed in a particular category and/or for a particular item.

FIGS. 43-44 depict example user interfaces that provide instructions to a teacher, parent, or other like individual for capturing one or more video segments.

FIG. 45 depicts an example user interface that allows a teacher, parent, or other like individual to preview a recorded video segment and/or to edit the video segment (e.g., by trimming portions of the video clip, by cropping portions of the video clip, by adjusting the audio of the video clip, etc.).

FIG. 46 depicts an example user interface that provides instructions to a teacher, parent, or other like individual for capturing one or more video segments.

FIG. 47 depicts an example user interface that allows a teacher, parent, or other like individual to preview a recorded video segment and/or to edit the video segment (e.g., by trimming portions of the video clip, by cropping portions of the video clip, by adjusting the audio of the video clip, etc.).

FIG. 48 depicts an example user interfaces that may be displayed when a teacher, parent, or other like individual is attempting to capture the first video segment, which can include an outline for a head position and/or an outline for a shoulders position.

FIG. 49 depicts an example user interface depicting a captured video segment.

FIG. 50 depicts an example user interface depicting one method for positioning the user device used to capture a video segment.

FIG. 51 depicts an example user interface depicting a captured video segment.

FIG. 52A depicts an example user interface showing a list of created video segments.

FIG. 52B depicts an example user interface showing additional information that is viewable when the user scrolls down.

FIG. 53 depicts an example user interface that indicates when a captured video segment has been saved.

FIG. 54A depicts an example user interface showing a list of created video segments.

FIG. 54B depicts an example user interface displaying additional information that is viewable when the user scrolls down the example user interface of FIG. 54A.

FIG. 55A depicts an example user interface showing a list of created video segments.

FIG. 55B depicts additional information that is viewable when the user scrolls down.

FIG. 56A depicts an example user interface showing a list of created video segments.

FIG. 56B depicts additional information that is viewable when the user scrolls down.

FIG. 57 depicts an example user interface that indicates when a captured video segment has been shared with the community.

FIG. 58A depicts an example user interface showing a list of created video segments.

FIG. 58B depicts additional information that is viewable when the user scrolls down.

FIG. 59 depicts an example user interface that allows a teacher, parent, or other like individual to share a video segment with the community.

FIG. 60 depicts an example user interface that allows a teacher, parent, or other like individual to assign a video clip to a user and/or to indicate a number of times the video clip should be repeated to the user.

FIG. 61 depicts an example user interface that allows a teacher, parent, or other like individual to redo the capture of a video segment.

FIG. 62 depicts a block diagram of an example operating environment in which a mobile application operates to instruct a student, in one embodiment.

FIG. 63 depicts a flow diagram illustrating an example process for adaptive education application instructing a user.

FIG. 64 depicts a block diagram of an example computing system configured to generate lessons and instruct a user.

### DETAILED DESCRIPTION

The present disclosure generally relates to a mobile application that can improve the ability of a user (e.g., a child, a student, etc.) to speak one or more words of a particular language and/or to understand spoken words of the particular language. For example, the mobile application allows a teacher, parent, or other like individual to generate a video clip that demonstrates how to pronounce the name of an item in a particular language and/or allows a teacher, parent, or other like individual to generate one or more tests using video clips generated via the mobile application to test a user's ability to comprehend the meaning of a word spoken in a particular language.

There are several factors that make this an improvement over the techniques that might be implemented by a real person. Many of these improvements come from the fact that the functionality of the mobile application and associated system are designed for those with learning disabilities. These people, by definition, have trouble learning from real people in standard settings. This platform uses many techniques that are specifically more effective than any real person could be.

Once such technique for ensuring the lessons provided by the system described herein are more effective than prior lessons or live teaching for individuals with learning disabilities is that the presentation filmed via the mobile application is filmed in a sensory-managed way. Most people with learning disabilities have problems with sensory overload. Neurological research has shown that when senses are overloaded, learning is difficult. As many “extraneous” sensory stimuli are removed in this methodology: the system described herein implements processing operations to ensure that the background is all white, makeup is minimized, hair is minimized, facial hair or ornaments (piercings) are taken away, extraneous words are not used, audio is crisp and clear and no extra words are used. No real-life situation allows for sensory inputs to be this controlled, so no real-life teacher could be this effective.

Another technique implemented by the system disclosed herein is that the mobile application and associated system allow for the pre-recording of videos in all languages in native accents. The mobile application and associated system also allows for the presentation of multiple languages at a time in the same lesson—in native accents—for bilingual children. Almost no therapist has the ability to present different languages in perfectly correct native accents. The mobile application and system therefore allow greater access for bilingual children to lessons incorporating their native languages in native accents, and allows for more consistent education without the potential gaps associated with finding therapists qualified to assist bilingual children whose educational needs change over time.

Additionally, the mobile application and system described herein ensure consistent delivery of educational material. People with special needs often have trouble learning unless information is presented in the exact same way, often to the point that flashcards need to be presented in the exact same way, or that an object they are learning about be placed in the exact same spot, which is nearly impossible for a human to accomplish. The anxiety these students experience when lessons are not presented as expected can be overwhelming and shut down all possibility of learning. Therapists often experience these clinical “meltdowns.” No human can ever replicate the exact consistency of pre-recorded lessons, where the lessons are recorded and presented in a consistent format as described below.

The mobile application provides an improvement over existing techniques for helping users pronounce and understand the meanings of words. For example, users like children often have specific interests that, when introduced in a learning experience, improve the likelihood that the users will retain information learned during the experience. Such interests can include vehicles, toys, animals, dolls, and/or the like. When trying to teach hundreds of users in person, however, it may be impractical for a teacher to customize the learning experience to include specific interests of each individual user. In addition, some users with learning disabilities (e.g., autism, down syndrome, etc.) may be in their most learnable state at random times during the day. A teacher trying to teach such users in person may happen to be teaching at a time at which the users are in a less learnable state, and it is impractical for the teacher to be on stand-by and able to teach when the users are in a more learnable state.

The mobile application and associated system described herein can overcome these deficiencies in in-person teaching by providing custom testing and continuous access to teaching resources, while providing additional technical benefits. For example, the mobile application can use an artificial intelligence model (e.g., machine learning model, neural network, etc.) to analyze viewing patterns and/or test results of various users and to automatically adjust the order of content of video clips presented during testing to improve the likelihood that the words and language being taught are retained by a user. In particular, the artificial intelligence model (e.g., machine learning model, neural network, etc.) may output an indication of an adjustment to be made to the order of content of a video clip based on various inputs to the model, such as the success (or failure) of one or more users taking a test that tests the users' knowledge after watching the video clip, an amount of time that one or more users have spent viewing a screen while watching the video clip (which may indicate user attention span), one or more users' viewing patterns of the video clip, one or more users' eye gaze when watching the video clip (e.g., what percentage of time taken to complete playing the video clip did a user look at the screen of the user device running the mobile application, how often did a user look away from the screen of the user device running the mobile application while the video clip was playing, etc.), speeds at which one or more users have answered questions that test the users' knowledge after watching the video clip, and/or the like. In fact, it may be impossible for a human to even use the time to answer a question as a metric in determining how to adjust the content of a video clip because the difference in time between a user that answers quickly a question that is based on the content of a video clip explaining how to pronounce the name of an item in a particular language (e.g., indicating that the order of the content in the video clip was effective) and a user that answers slowly a question that is based on the content of a video clip explaining how to pronounce the name of an item in a particular language (e.g., indicating that the order of the content in the video clip was ineffective) may be too short to be perceptible by a human (e.g., microseconds, nanoseconds, etc.).

As described herein, the mobile application may provide a video clip generation function and a testing function. In the video clip generation function, the mobile application may request certain information from the teacher, parent, or other like individual, such as the language(s) in which to view text in the mobile application and the language to which the teacher, parent, or other like individual will be translating names of items. The mobile application may display a list of items for which a video clip has already been generated and/or a list of items for which a video clip has not yet been generated. The teacher, parent, or other like individual can select an item for which a video clip has not yet been generated, which may cause the mobile application to display prompts and/or other information that explains how the teacher, parent, or other like individual should capture video to be used in generating the video clip. For example, the mobile application may prompt the teacher, parent, or other like individual to capture one or more video segments. A first video segment may be a mid-shot video segment in which the captured video includes the head and shoulders of the teacher, parent, or other like individual as the teacher, parent, or other like individual is pronouncing the name of the item in the selected translation language. A second video segment may be a close-up video segment in which the captured video includes the mouth of the teacher, parent, or other like individual as the teacher, parent, or other like individual is pronouncing the name of the item in the selected translation language. A third video segment may be a skit video segment in which the captured video includes two or more persons conversing in the selected translation language.

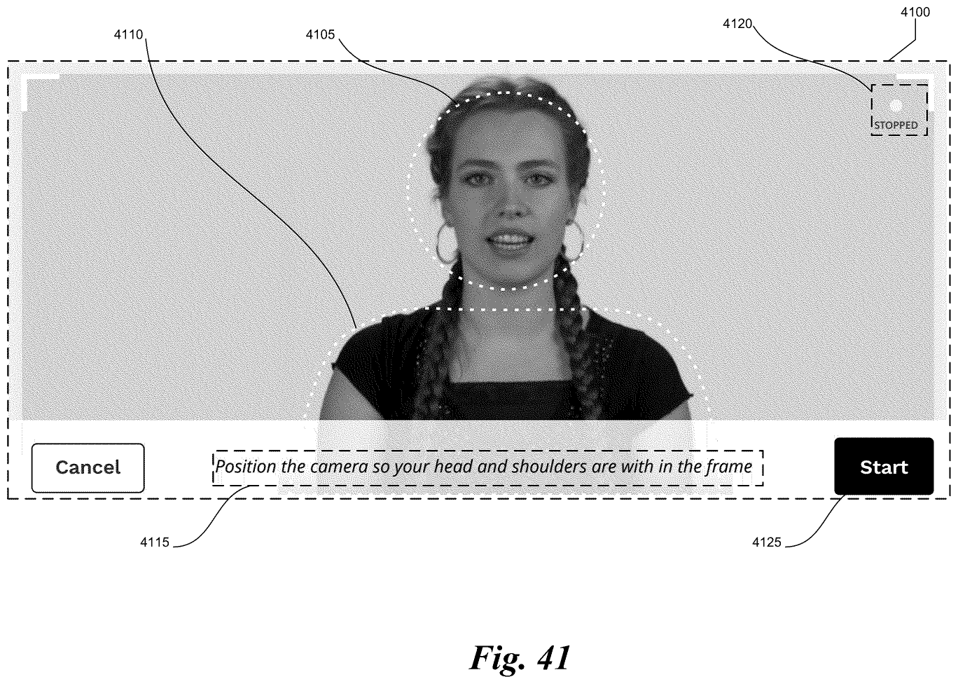

The mobile application may include an outline or shape within which the teacher, parent, or other like individual is to position himself or herself to capture the first, second, and/or third video segments. The mobile application can use image processing techniques to determine whether the person's head is positioned within an area of the screen at which the head should be positioned, whether the user's shoulders are positioned within an area of the screen at which the shoulders should be positioned, and/or the like. This consistency in location for the person's face, mouth, shoulders, etc. that the mobile application enforces is important for sensory processing and cannot be replicated by a real-life therapist. For example, the mobile application can use image processing techniques and/or facial recognition technology to identify a person's head in an image or video captured by a camera of the user device running the mobile application and displayed on the screen of the user device. The screen may further overlay an outline of a head, shoulders, a mouth, and/or the like over the image or video captured by the camera of the user device and displayed on the screen (see FIGS. 41 and/or 48). The mobile application can then use edge detection techniques to determine whether the identified head is positioned within a head outline that appears on the screen, whether the identified shoulders are positioned within a shoulders outline that appears on the screen, whether the identified mouth is positioned within a mouth outline that appears on the screen, etc. If the mobile application determines that a head, the shoulders, the mouth, and/or the like fall partially or fully outside the designated outline, the mobile application can display an error message or otherwise notify the teacher, parent, or other like individual that the relevant portion of the body is incorrectly positioned and to either re-position the person's body or re-position the camera of the user device. Optionally, the mobile application may prevent video capture until the person is positioned correctly inside the designated outline(s).

Once captured, the mobile application and/or the associated system may stitch some or all of the video segments together with other data to form a video clip. For example, the mobile application and/or associated system may extract the audio from the first video segment and/or the second video segment, and generate a fourth video segment (also referred to herein as a “generalization” video segment) that depicts a graphical image or video of the item spoken in the first and/or second video segment and that includes the extracted audio as the audio track of the video segment. The mobile application and/or associated system may also modify the first video segment to include a graphical image or video of the item spoken in the first video segment positioned adjacent to the head or shoulders of the person speaking in the first video segment (e.g., to the right or left of the head or shoulders of the person speaking in the first video segment), thereby forming a modified first video segment. Optionally, the mobile application and/or associated system can use audio filtering techniques to reduce background noise and/or to increase the decibel level of one or more frequencies corresponding to the voice of the teacher, parent, or other like individual.

The mobile application and/or associated system can then generate a video clip that includes a combination of the first video segment, the modified first video segment, the second video segment, the third video segment, and/or the fourth video segment. As an illustrative example, the mobile application and/or associated system can generate the video clip such that a first portion of the video clip is the modified first video segment, a second portion of the video clip is the second video segment (which is stitched to the modified first video segment), a third portion of the video clip is the fourth video segment (which is stitched to the stitched modified first and second video segments), a fourth portion of the video clip is the second video segment (which is stitched to the stitched modified first, second, and fourth video segments), and a fifth portion of the video clip is the first video segment (which is stitched to the stitched modified first, second, fourth, and second video segments).

While the present disclosure provides an example of an order in which the first video segment, the modified first video segment, the second video segment, the third video segment, and/or the fourth video segment are stitched together, this is not meant to be limiting. For example, the mobile application and/or associated system can stitch the video segments in any possible order and/or include any one video segment one or more times in the generated video clip. In fact, as described herein, the mobile application and/or associated system can use artificial intelligence to set and/or modify the order in which the video segments are stitched. For example, the associated system can train an artificial intelligence model to output an indication of which video segments to include in a video clip and/or the order in which the video segments should be stitched together to form the video clip using training data. The training data can include, for one or more video clips, the prior success (or failure) of one or more users taking a test that tests the users' knowledge after watching the respective video clip, an amount of time that one or more users have spent viewing a screen while watching the respective video clip (which may indicate user attention span), one or more users' viewing patterns of the respective video clip, one or more users' eye gaze when watching the respective video clip (e.g., what percentage of time taken to complete playing the respective video clip did a user look at the screen of the user device running the mobile application, how often did a user look away from the screen of the user device running the mobile application while the respective video clip was playing, etc.), speeds at which one or more users have answered questions that test the users' knowledge after watching the respective video clip, and/or the like, where each portion of the training data associated with a particular video clip may be labeled with an indication of the ordering of the video clips that form the particular video clip. Once trained, a mobile application and/or the associated system can access the artificial intelligence model and use the artificial intelligence model to determine how to adjust the order of the video segments of the video clip, if at all, in a manner as described above.

The associated system can store video clips generated by one or more teachers, parents, or other like individuals. Thus, the associated system may store a library of video clips, with each video clip corresponding to a particular item, a particular language, a particular age of a person featured in the video clip, a particular race of a person featured in the video clip, a particular regional accent or dialect of a person featured in the video clip, a particular sex of a person featured in the video clip, a particular speech impairment of a person featured in the video clip, and/or the like.

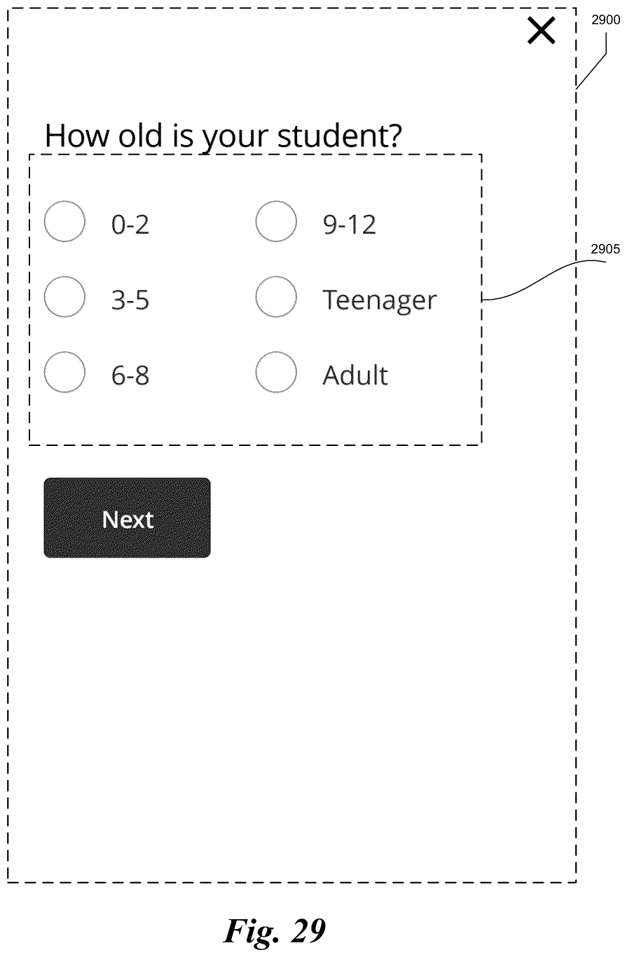

A mobile application can access one or more video clips via a network connection with the associated system. When a video clip is generated, the teacher, parent, or other like individual can select whether the video clip is to be shared with the community or whether the video clip is to be private to the teacher, parent, or other like individual and/or particular user. When logged into the mobile application, the teacher, parent, or other like individual can view a list of video clips that have been generated and have been shared with the community, a list of video clips generated by the teacher, parent, or other like individual (that may or may not have been shared with the community), and/or a list of video clips that have yet to be generated. Each video clip may be associated with a particular item and/or language. A dropdown menu or other similar user interface element may be present adjacent to one or more listed video clips that, when selected, allow a teacher, parent, or other like individual to view different versions of the video clip if available. Different versions can include versions generated by a person of a particular age, of a particular race, having a particular regional accent or dialect, of a particular sex, having a particular speech impairment, and/or the like. When setting up an account or when logging in, the mobile application may ask the teacher, parent, or other like individual of biographical characteristics of the user that will be watching video clips (e.g., age, race, regional accent or dialect to be spoken, sex, speech impairment, etc.) (see FIGS. 29-35). Thus, initially the mobile application may present to the teacher, parent, or other like individual a version of a video clip that most closely matches the biographical characteristics of the user. However, the teacher, parent, or other like individual can use the dropdown menu to select another version of the video clip to view if so desired.

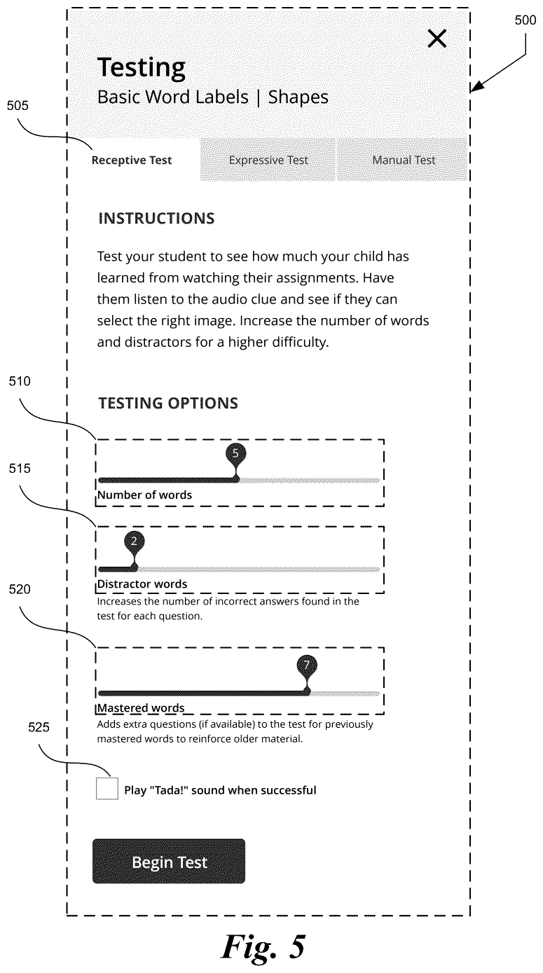

In the testing function, the mobile application provides a teacher, parent, or other like individual with one or more sliders that allow the teacher, parent, or other like individual to customize the test to a particular user (see FIG. 5). For example, a first slider may allow the teacher, parent, or other like individual to set the number of words in a category (e.g., animals, vehicles, toys, plants, etc.) to test, where each word is to be tested separately. A second slider may allow the teacher, parent, or other like individual to set the number of distractor words (e.g., words that are similar to, but not the same as, the word being tested, such as the name of items in the same category as the item names that are being tested) that are to be displayed in conjunction with the word to be tested. A third slider may allow the teacher, parent, or other like individual to set the number of mastered words (e.g., words that the teacher, parent, or other like individual knows the user has mastered) that are to be tested in addition to the other words that are being tested as indicated by the first slider. Once the slider(s) are set, the mobile application can construct a test for one or more words. A test for a word may include a graphical image or video of the word being tested (e.g., the same graphical image or video included in the fourth video segment) and graphical image(s) or video(s) of one or more distractor words. The audio extracted from the first and/or second video segment in which the word to be tested is spoken may then be played, thereby prompting the user to select the graphical image or video corresponding to the word spoken in the played audio. The mobile application and/or associated system can track the success (or failure) of various tests administered to users, along with some or all of the other data described herein that can, for example, be used to train or run the artificial intelligence model.

The mobile application may run on a user device, such as a desktop computer, laptop, and a mobile phone. In general, the user device can be any computing device such as a desktop, laptop or tablet computer, personal computer, wearable computer, server, personal digital assistant (PDA), hybrid PDA/mobile phone, mobile phone, electronic book reader, set-top box, voice command device, camera, digital media player, and the like. A user device may execute the mobile application or a third-party application (e.g., a browser) that can access the functionality of the mobile application described herein via a network page (e.g., a web page).

The mobile application, via the user device, can communicate with the associated system over a network. The network may include any wired network, wireless network, or combination thereof. For example, the network may be a personal area network, local area network, wide area network, over-the-air broadcast network (e.g., for radio or television), cable network, satellite network, cellular telephone network, or combination thereof. As a further example, the network may be a publicly accessible network of linked networks, possibly operated by various distinct parties, such as the Internet. In some embodiments, the network may be a private or semi-private network, such as a corporate or university intranet. The network 6270 may include one or more wireless networks, such as a Global System for Mobile Communications (GSM) network, a Code Division Multiple Access (CDMA) network, a Long Term Evolution (LTE) network, or any other type of wireless network. The network 6270 can use protocols and components for communicating via the Internet or any of the other aforementioned types of networks. For example, the protocols used by the network 6270 may include Hypertext Transfer Protocol (HTTP), HTTP Secure (HTTPS), Message Queue Telemetry Transport (MQTT), Constrained Application Protocol (CoAP), and the like. Protocols and components for communicating via the Internet or any of the other aforementioned types of communication networks are well known to those skilled in the art and, thus, are not described in more detail herein.

The associated system may be a computing system that is a single computing device, or it may include multiple distinct computing devices, such as computer servers, logically or physically grouped together to collectively operate as a server system. The components of the computing system can each be implemented in application-specific hardware (e.g., a server computing device with one or more ASICs) such that no software is necessary, or as a combination of hardware and software. In addition, the modules and components of the computing system can be combined on one server computing device or separated individually or into groups on several server computing devices.

In some embodiments, the features and services provided by the computing system may be implemented as web services consumable via the network. In further embodiments, the computing system is provided by one more virtual machines implemented in a hosted computing environment. The hosted computing environment may include one or more rapidly provisioned and released computing resources, which computing resources may include computing, networking and/or storage devices. A hosted computing environment may also be referred to as a cloud computing environment.

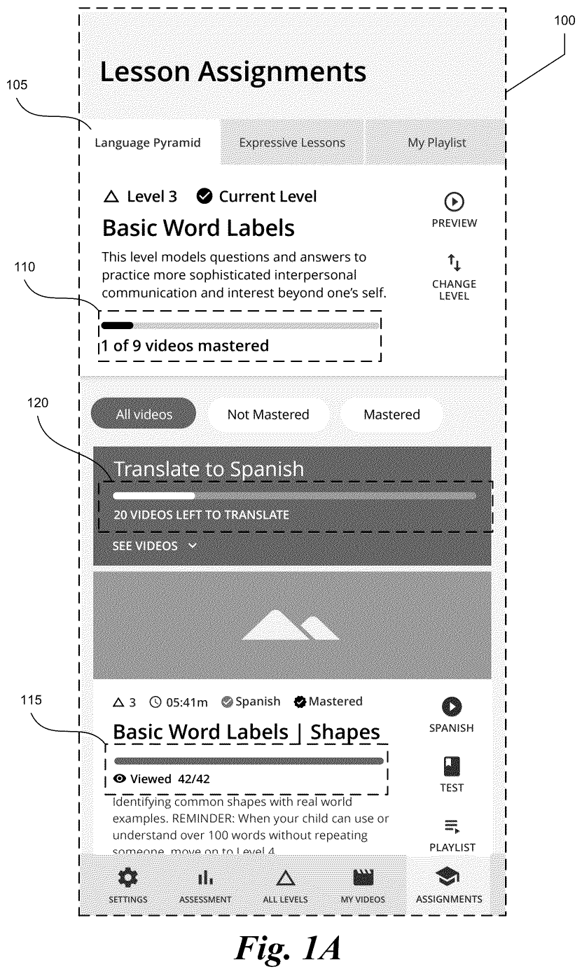

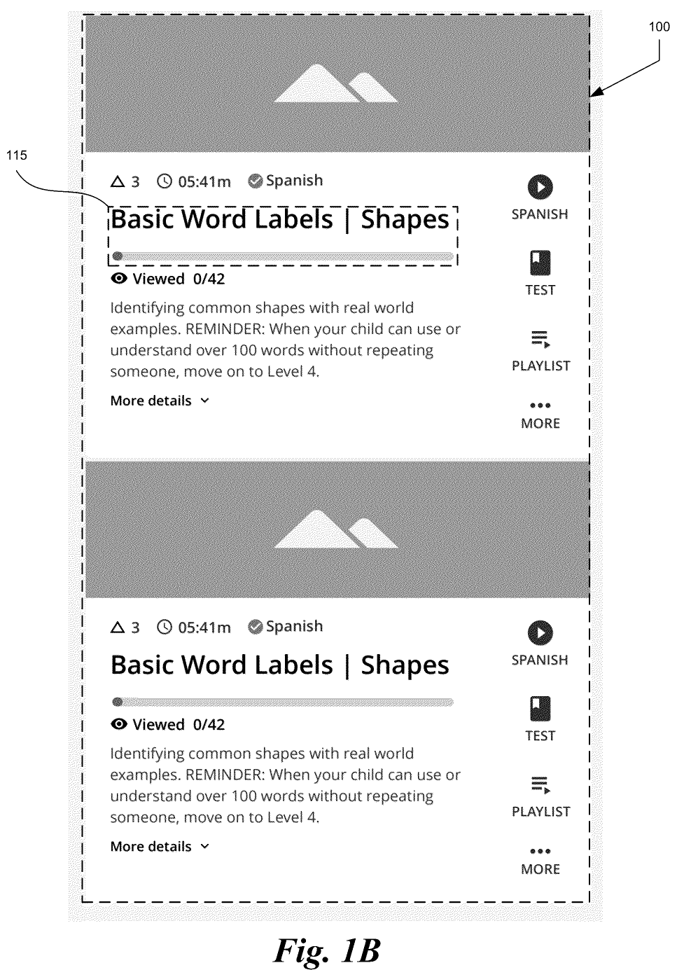

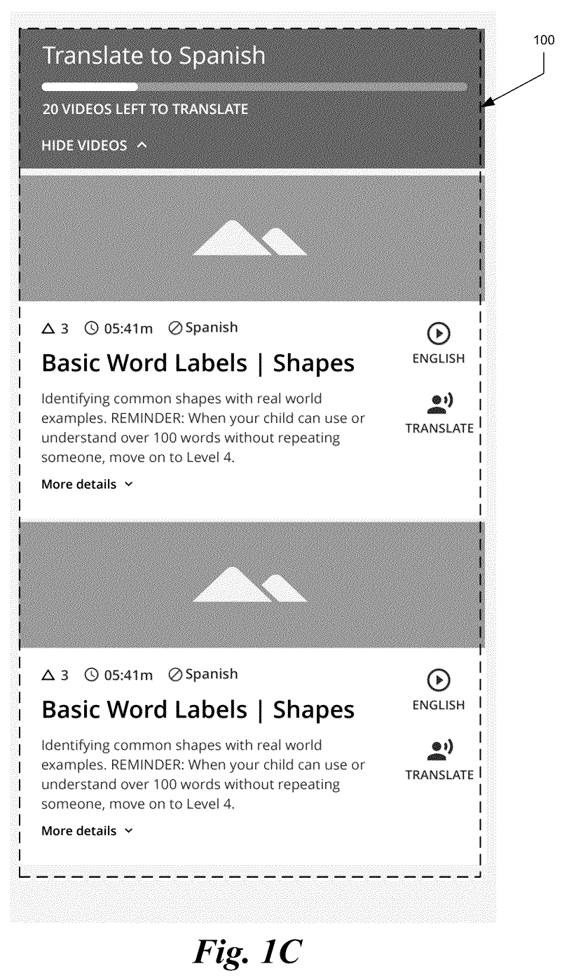

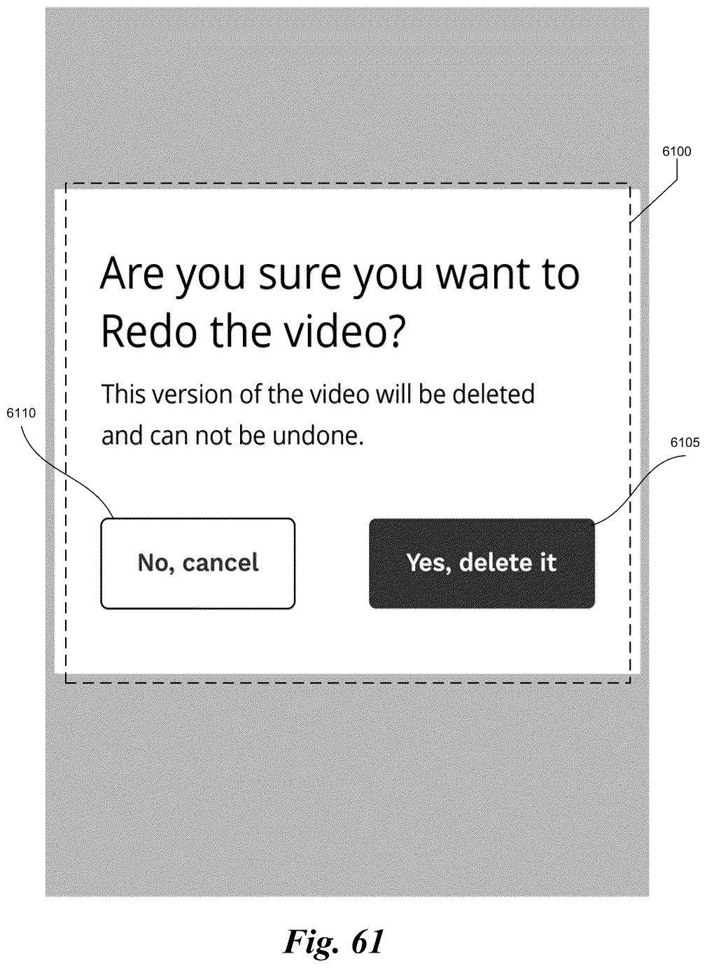

FIGS. 1A through 61 depict various user interfaces that may be rendered and displayed by a user device running the mobile application and that enable some or all of the functionality described herein.

FIG. 1A depicts a user interface 100 in which the language pyramid tab 105 is selected that allows a teacher, parent, or other like individual to view which video clips at a particular level have been mastered by a user via a mastery progress indicator 110 and/or a number of videos left to translate into the selected translation language as a translation progress indicator 120. Mastery may be determined by a machine learning model, as described in further detail below. Additionally, the user interface displays a viewed progress bar 115 indicating the number of lessons viewed in the associated lesson.

FIGS. 1B-1C depict additional information that is viewable when the user scrolls down in user interface 100.

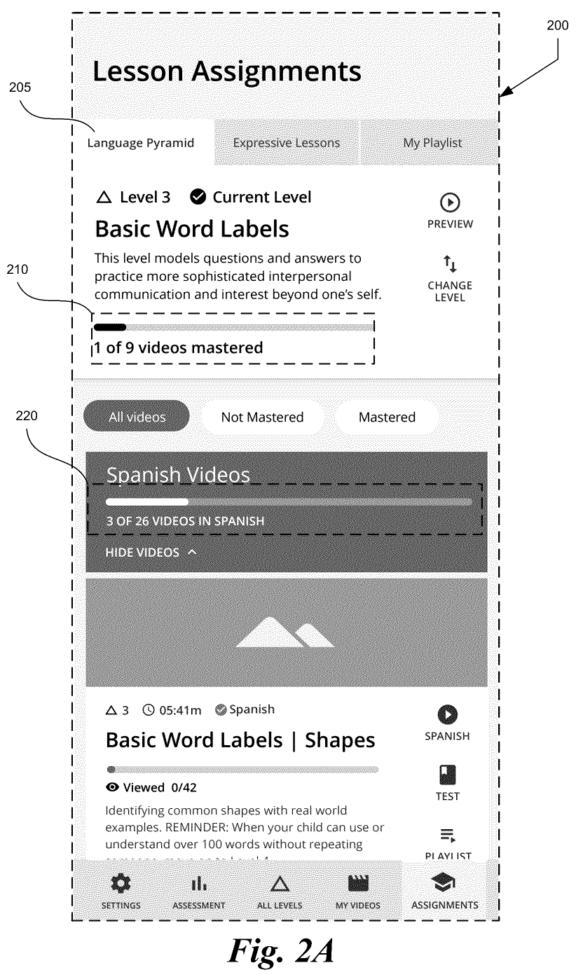

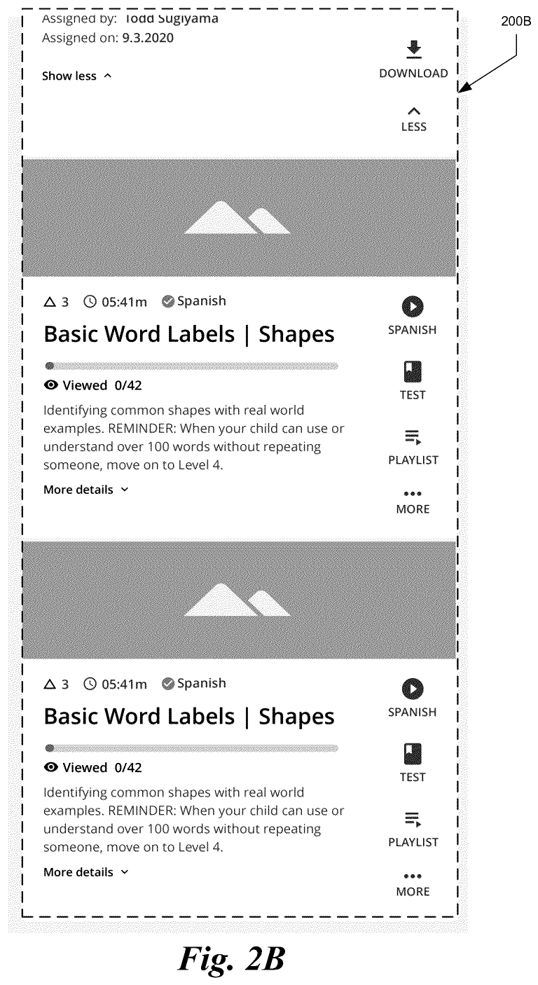

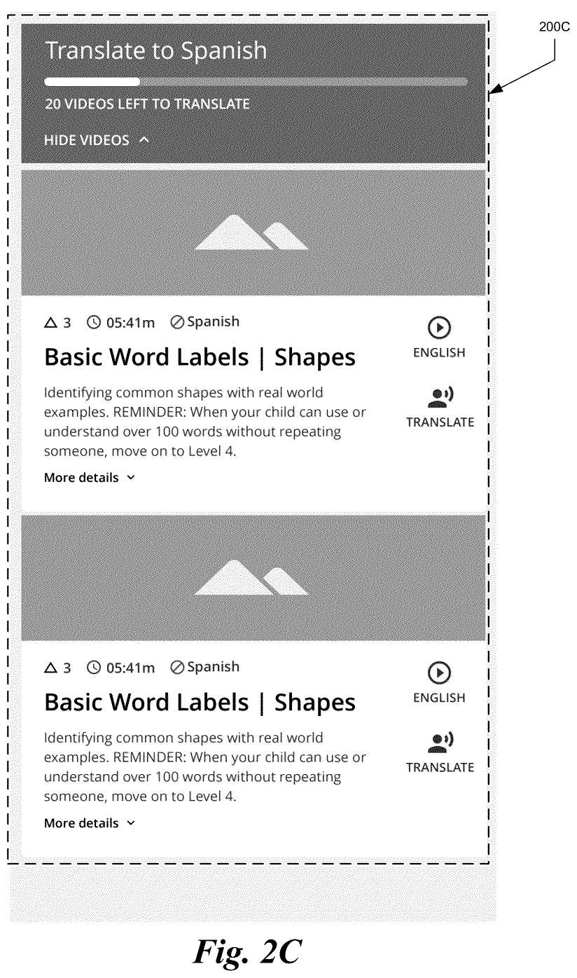

FIG. 2A depicts an example user interface 200 in which the language pyramid tab 205 is selected that allows a teacher, parent, or other like individual to view which video clips at a particular level have been mastered by a user via a mastery progress bar 210 and/or a number of videos left to translate into the selected translation language via a translation progress bar.

FIGS. 2B-2C depict additional information that is viewable when the user scrolls down in user interface 200.

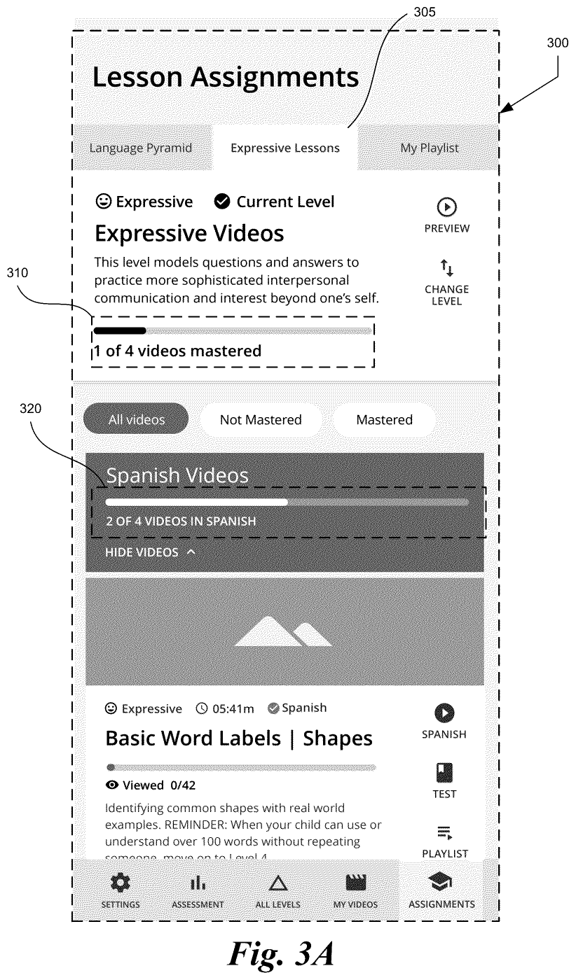

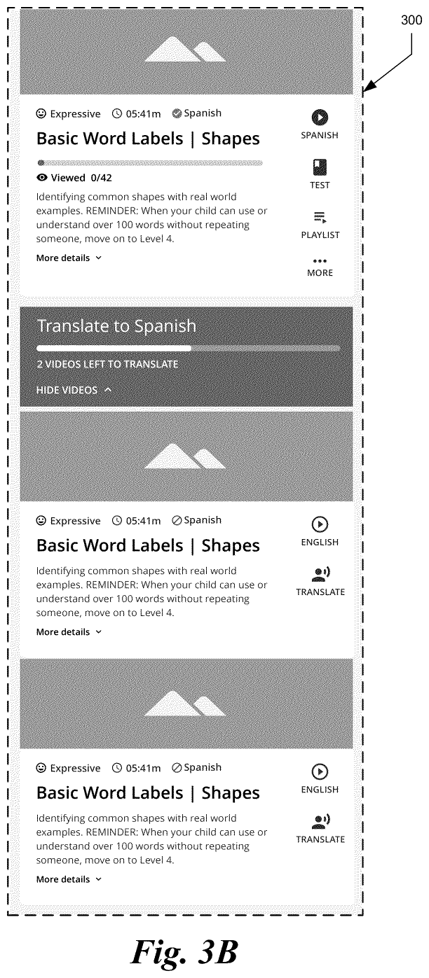

FIG. 3A depicts an example user interface 300 in which the expressive lessons tab 305 is selected that allows a teacher, parent, or other like individual to view which video clips at a particular level that have been mastered by a user via a mastery progress bar 310 and/or a number of videos left to translate into the selected translation language via translation progress bar 320.

FIG. 3B depicts additional information that is viewable when the user scrolls down the user interface 300.

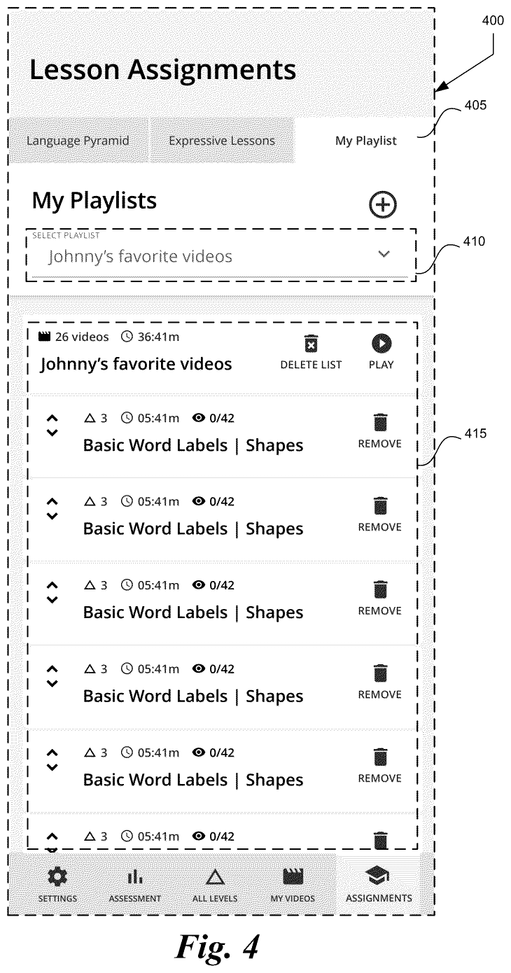

FIG. 4 depicts an example user interface 400 in which the my playlist tab 405 is selected using the playlist menu 410 that allows a teacher, parent, or other like individual to view a list of video clips 415 added to a user's playlist.

FIG. 5 depicts an example user interface 500 with the receptive test tab 505 selected that allows a teacher, parent, or other like individual to set one or more sliders for conducting a receptive test. For example, a number of words slider 510, a distractor words slider 515, or a mastered words slider 520. Additionally, a sound may be selected using a selection box 525 to be played, for example, when a learned has answered a question correctly or otherwise been successful in a lesson.

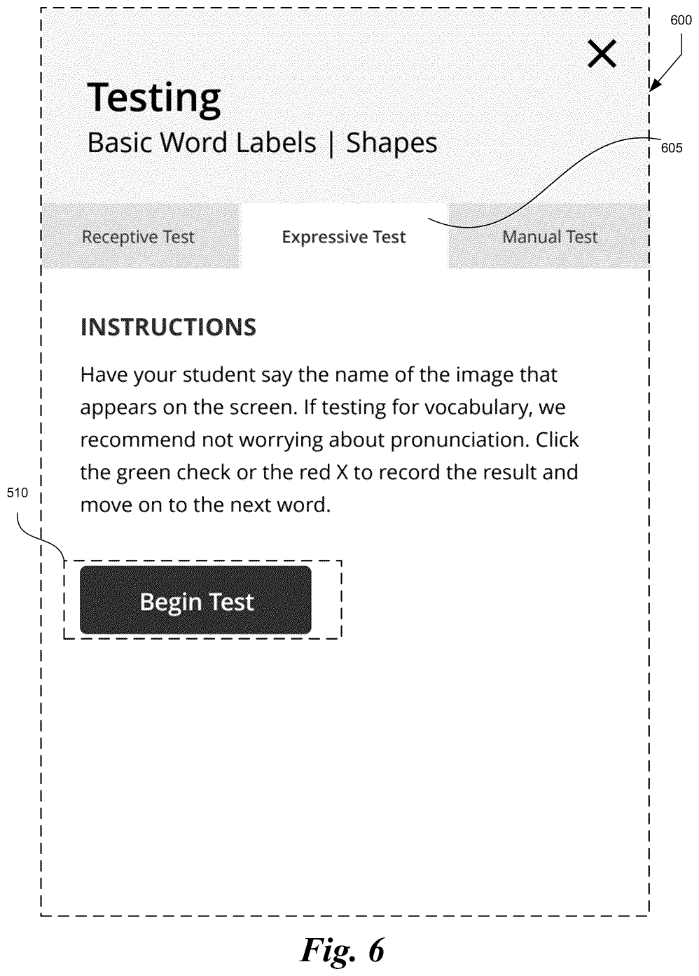

FIG. 6 depicts an example user interface that provides instructions for running an expressive test with the expressive test tab selected. The test may be started using a button 610.

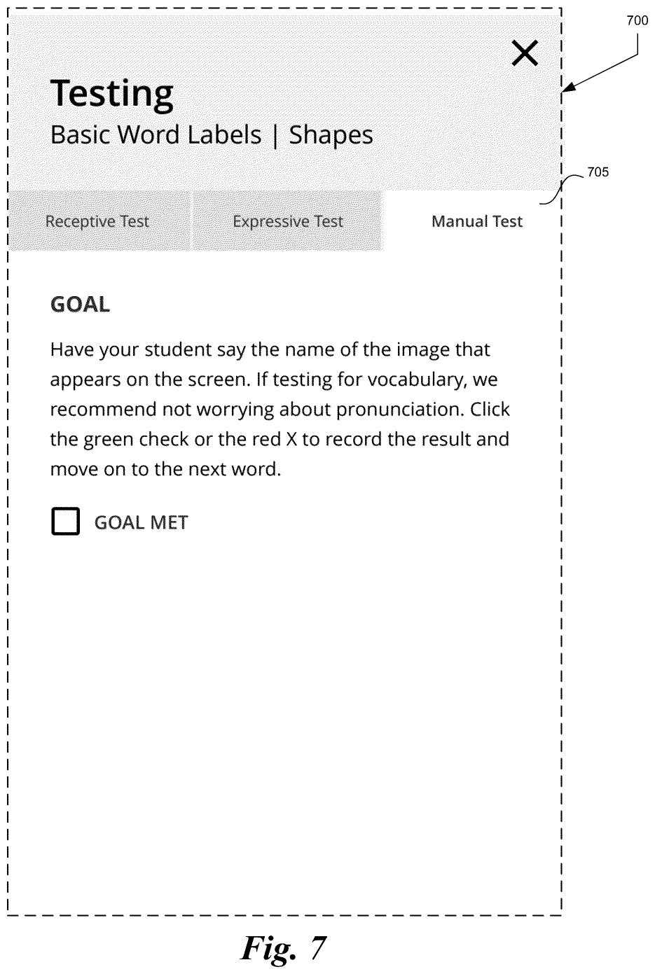

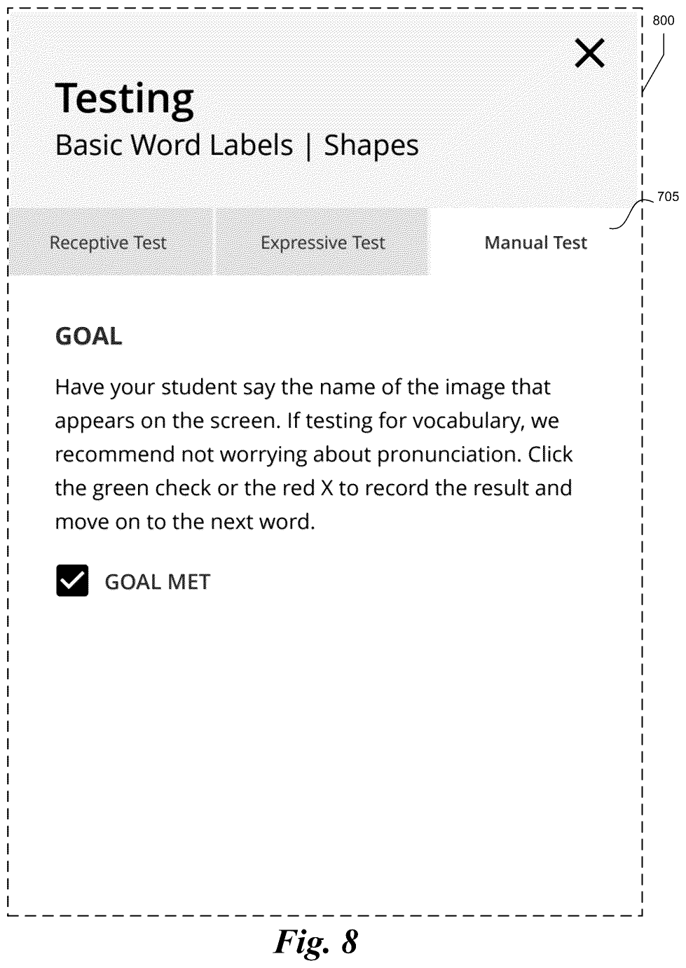

FIGS. 7-8 depict example user interfaces user interface 700 and user interface 800 that provides instructions for running a manual test when the manual test tab 705 is selected.

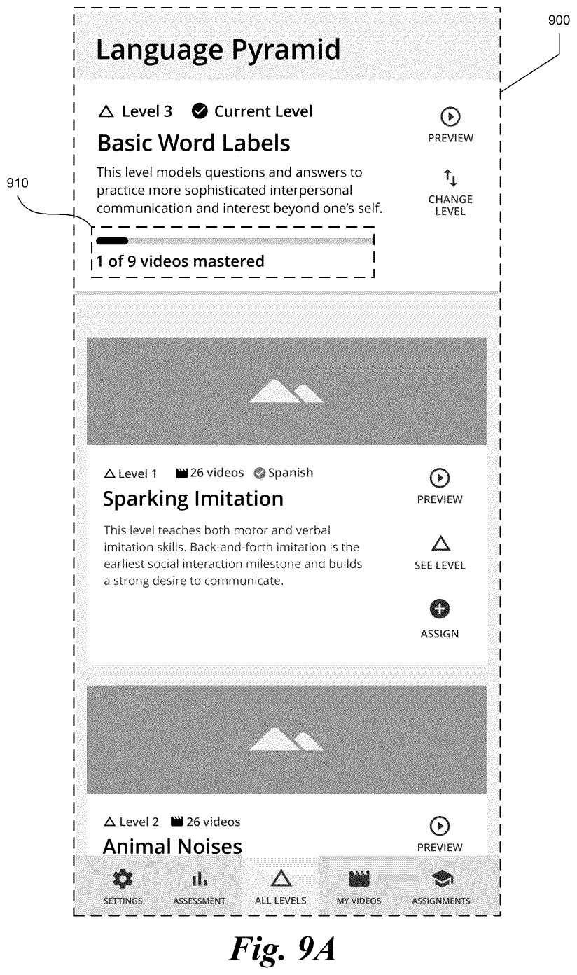

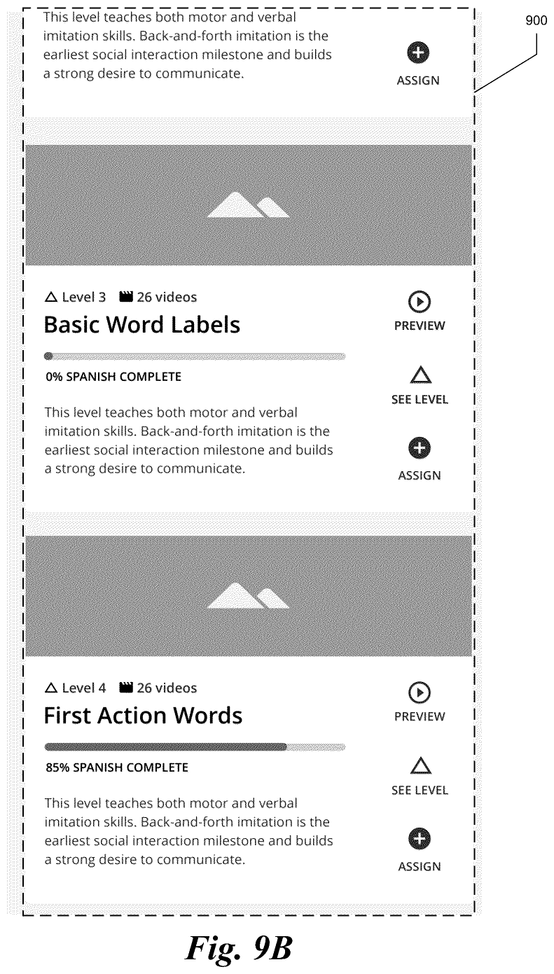

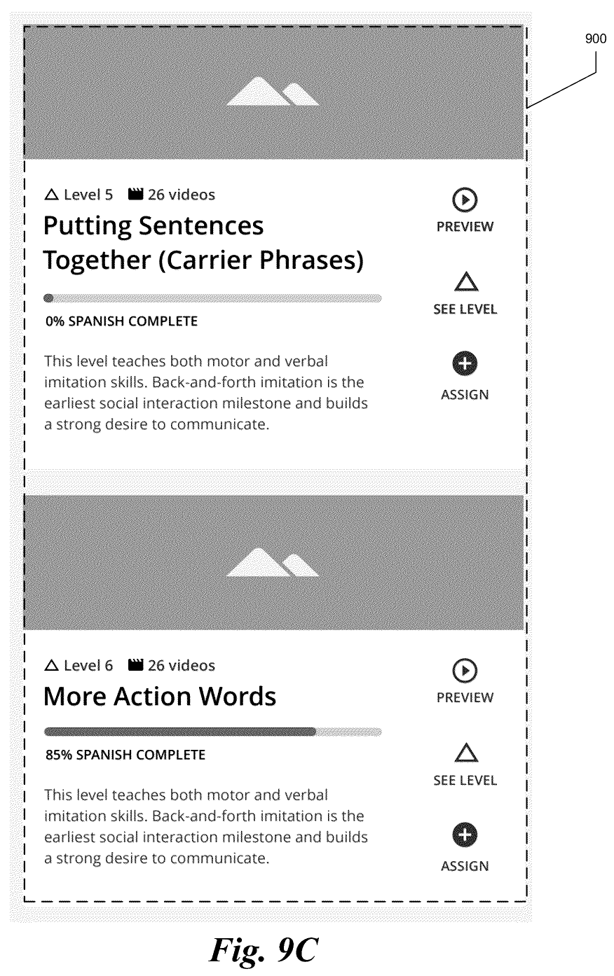

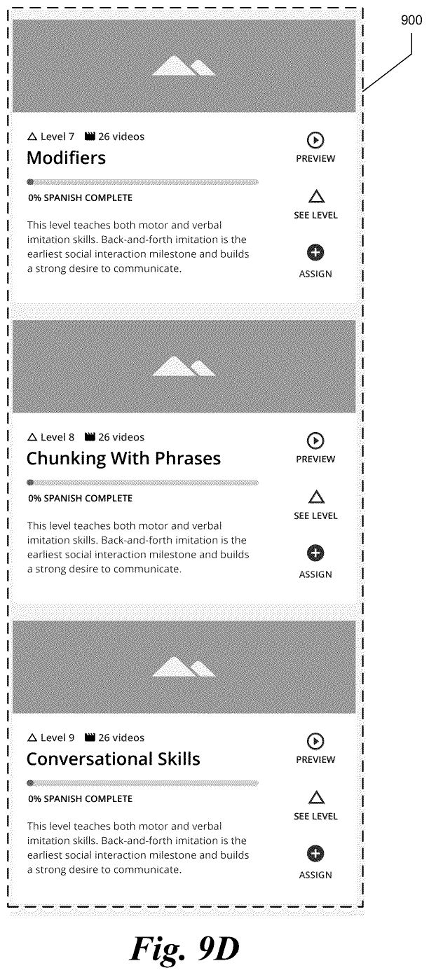

FIG. 9A depicts an example user interface 900 in which the language pyramid tab (e.g., language pyramid tab 105) is selected that allows a teacher, parent, or other like individual to view which video clips at a particular level that have been mastered by a user via a mastery progress bar. FIGS. 9B-9D depict additional information that is viewable when the user scrolls down user interface 900.

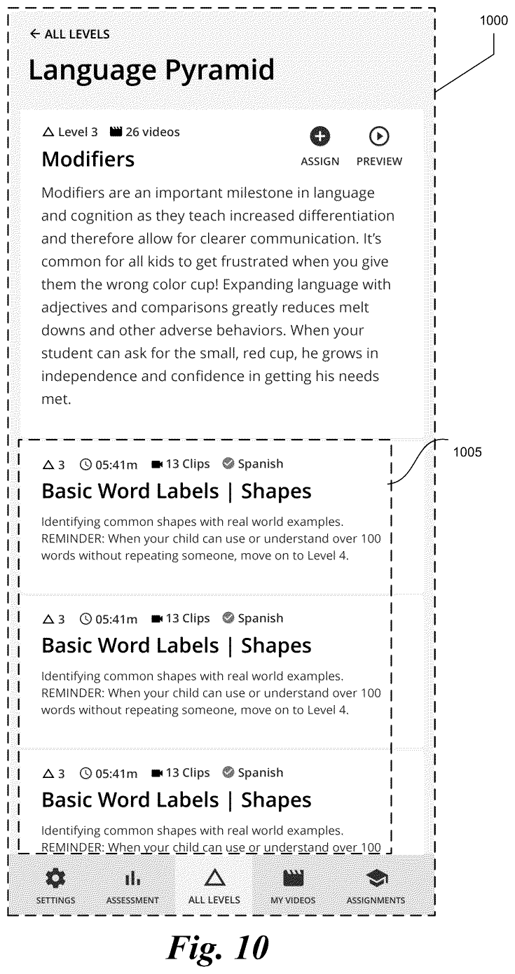

FIG. 10 depicts an example user interface 1000 in which the language pyramid tab (e.g., language pyramid tab 105) is selected that allows a teacher, parent, or other like individual to view a list of video clips 1005 at a particular level. A level may be determined based on a user input, a mastery obtained in one or more lessons or topic areas, or an analysis performed, for example, by a machine learning model and based on a student's progress in the lessons, engagement with the lesson material, or other like factors.

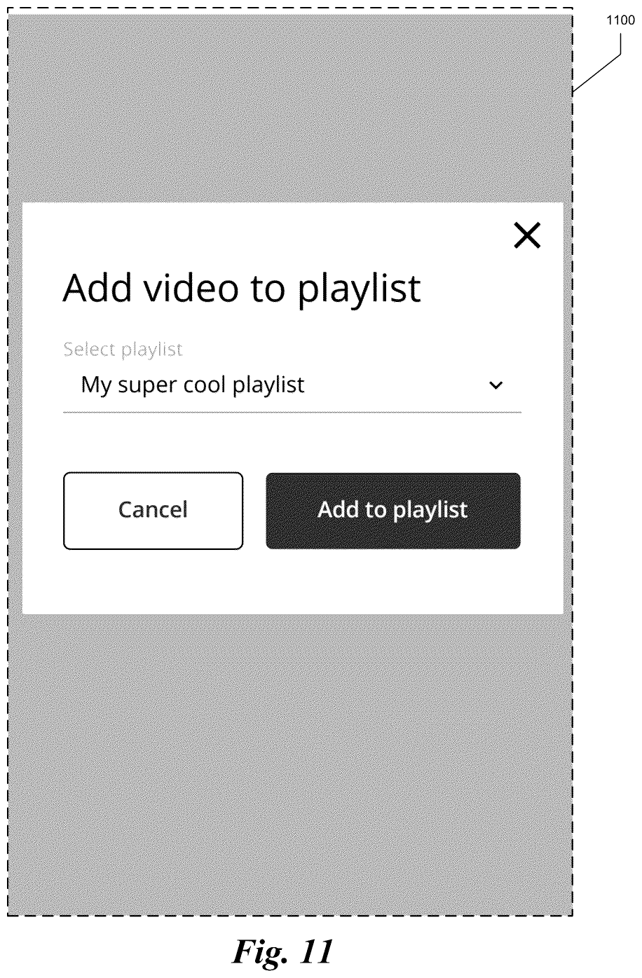

FIG. 11 depicts an example user interface 1100 for adding a video clip to a playlist.

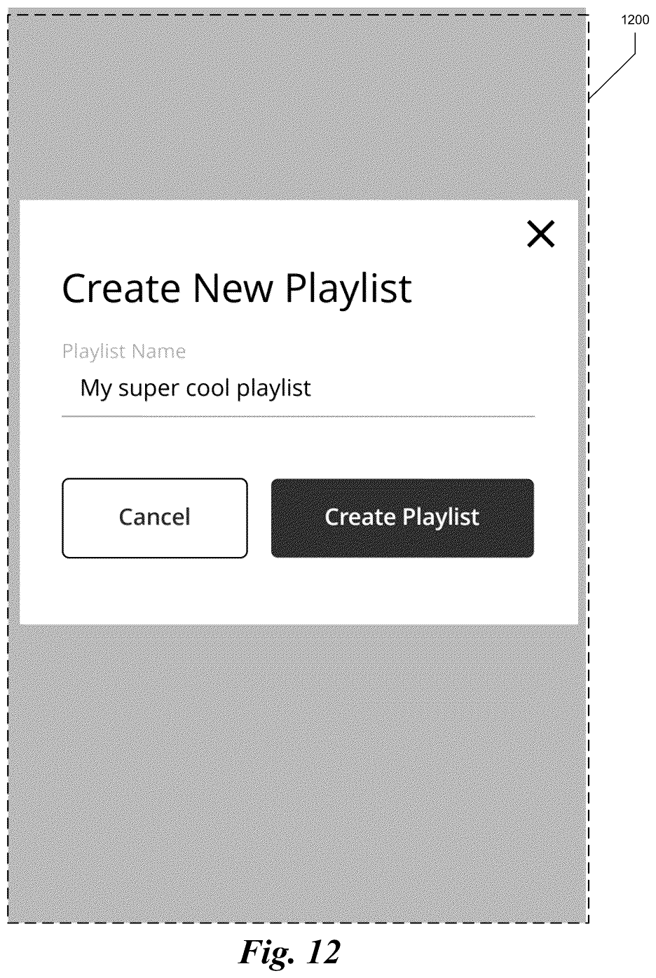

FIG. 12 depicts an example user interface 1200 for creating a new playlist.

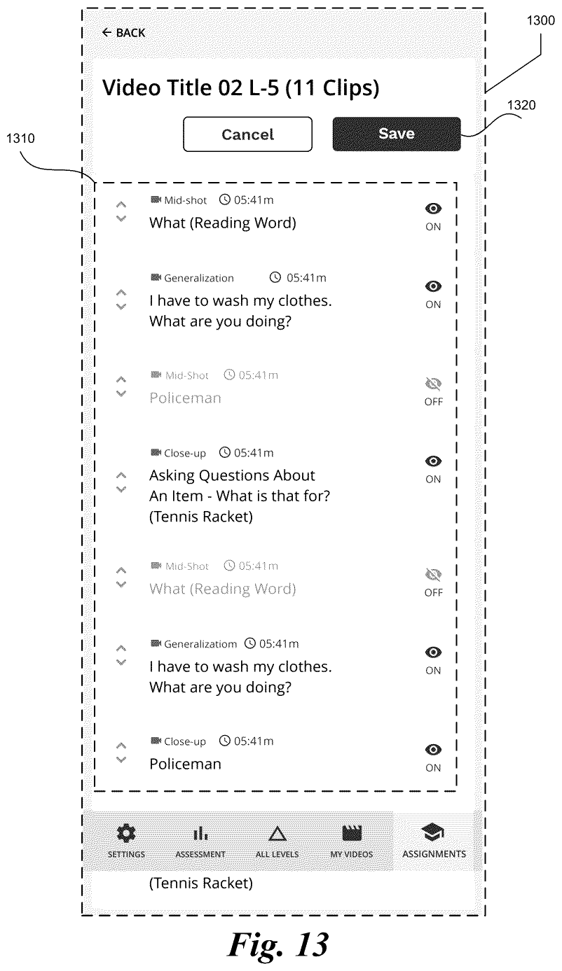

FIG. 13 depicts an example user interface 1300 that depicts a list of video segments 1310 captured by a teacher, parent, or other like individual. The user of the application may save one or more video segments of the list of video segments using, for example a button 1320.

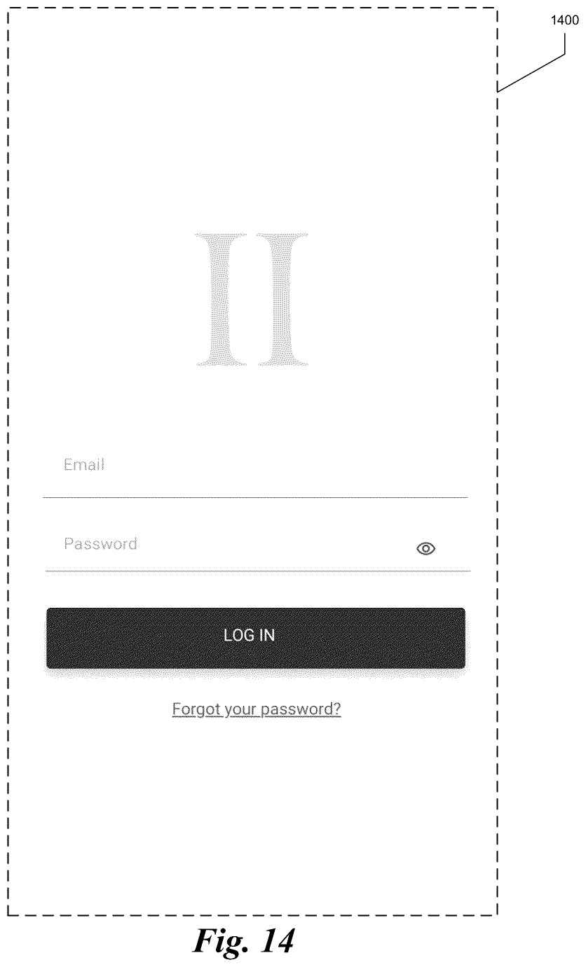

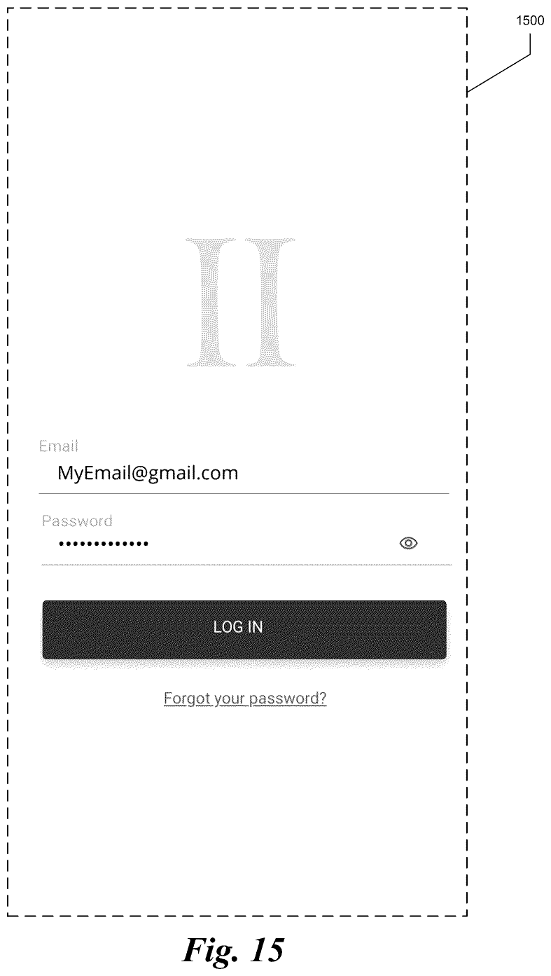

FIGS. 14-15 depict example log in screens log in screen 1400 and log in screen 1500 to access a user account.

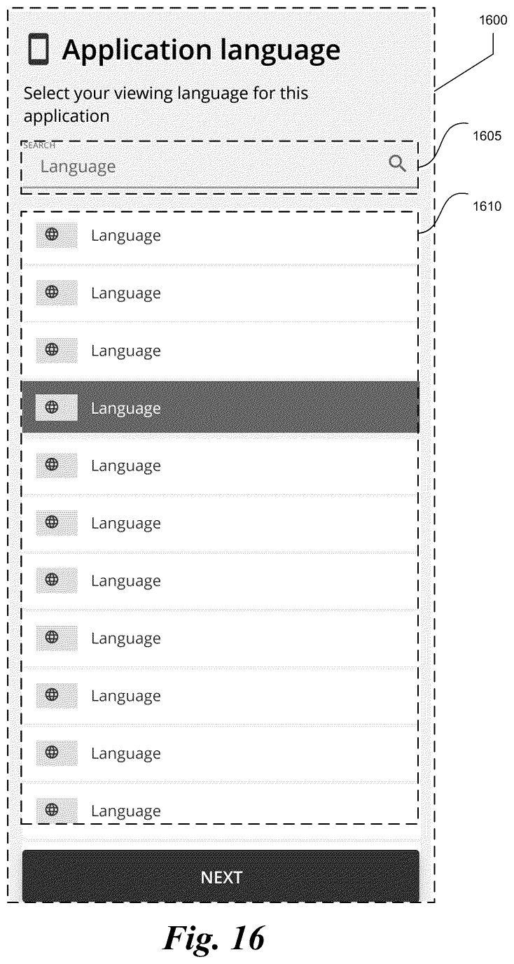

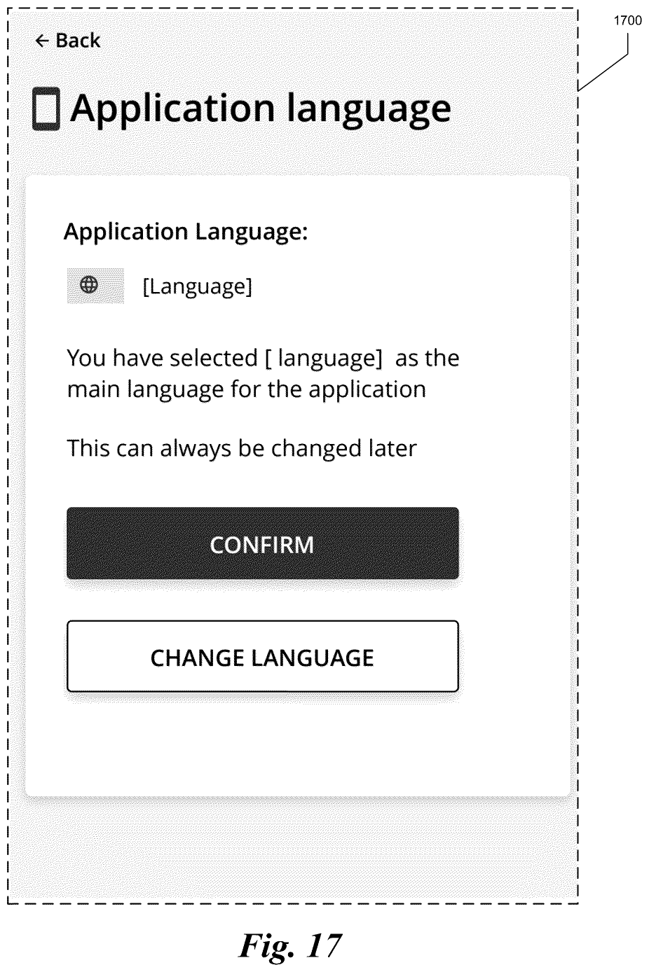

FIGS. 16-17 depict example user interfaces user interface 1600 and user interface 1700 for selecting a viewing language, for example from a language list 1610. Additionally, a user may search for a language by using, for example, search bar 1605.

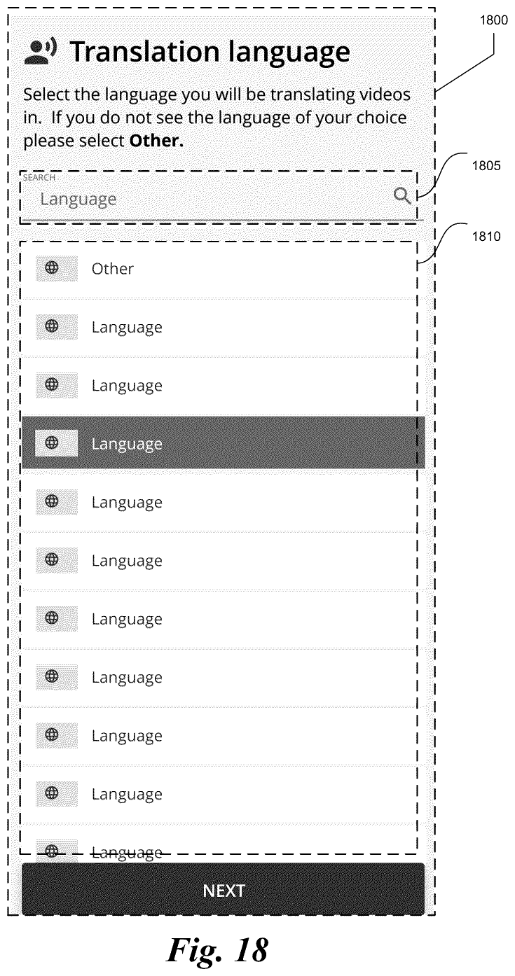

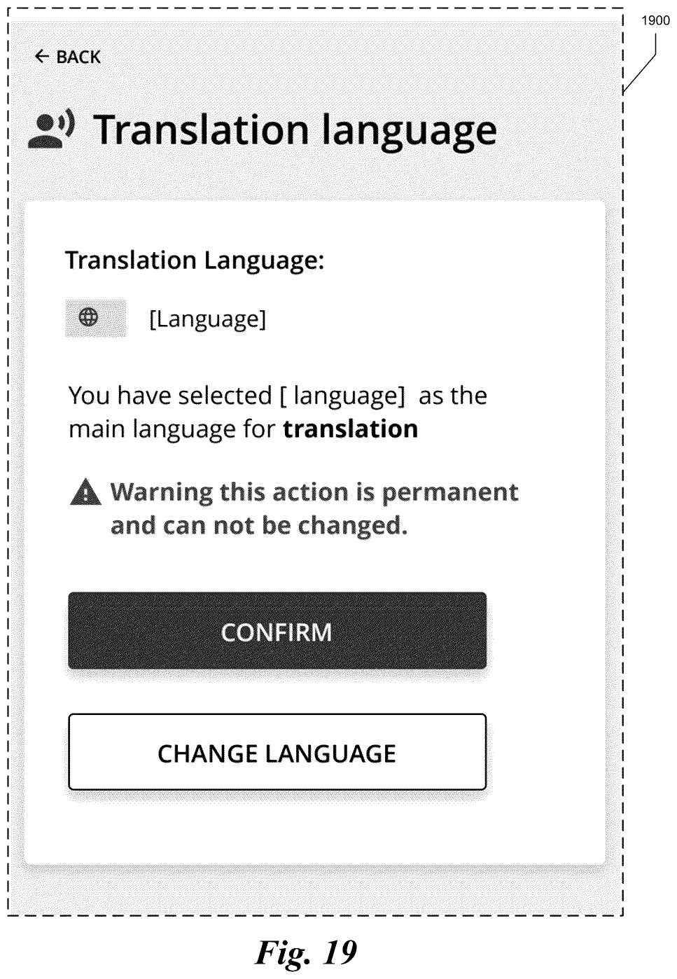

FIGS. 18-19 depict example user interfaces user interface 1800 and user interface 1900 for selecting a translation language, for example from a language list 1810. Additionally, a user may search for a language by using, for example, search bar 1805.

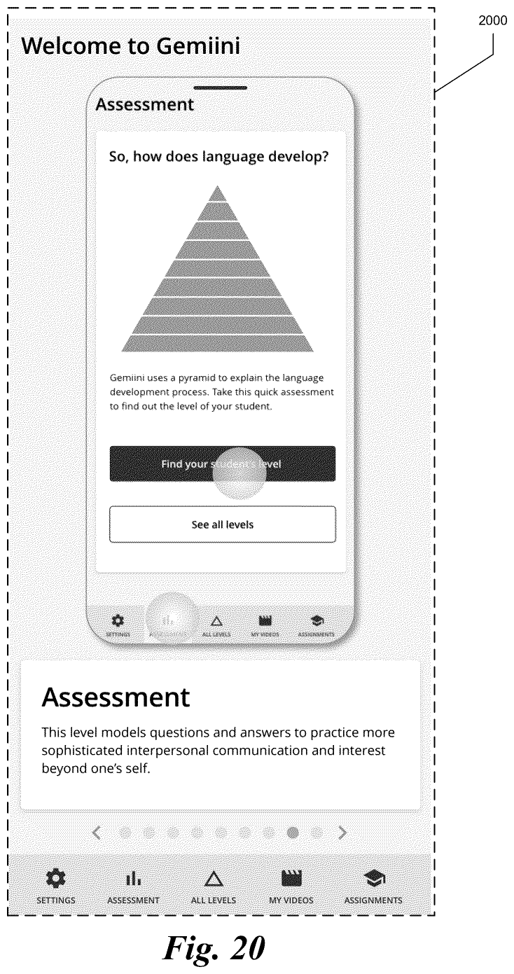

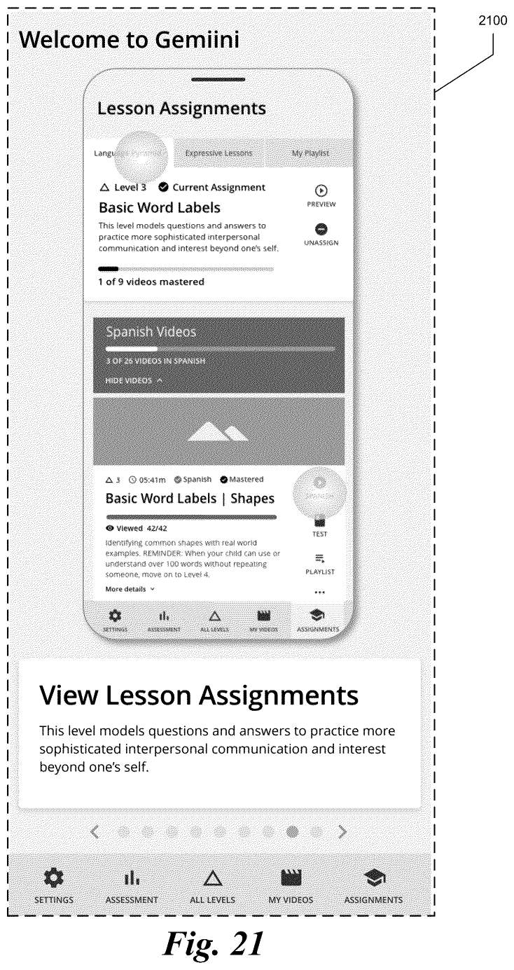

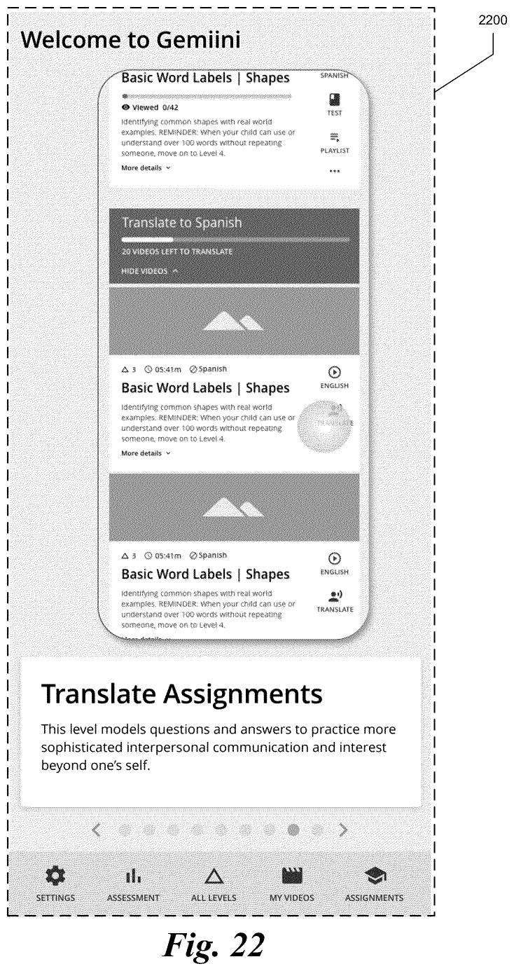

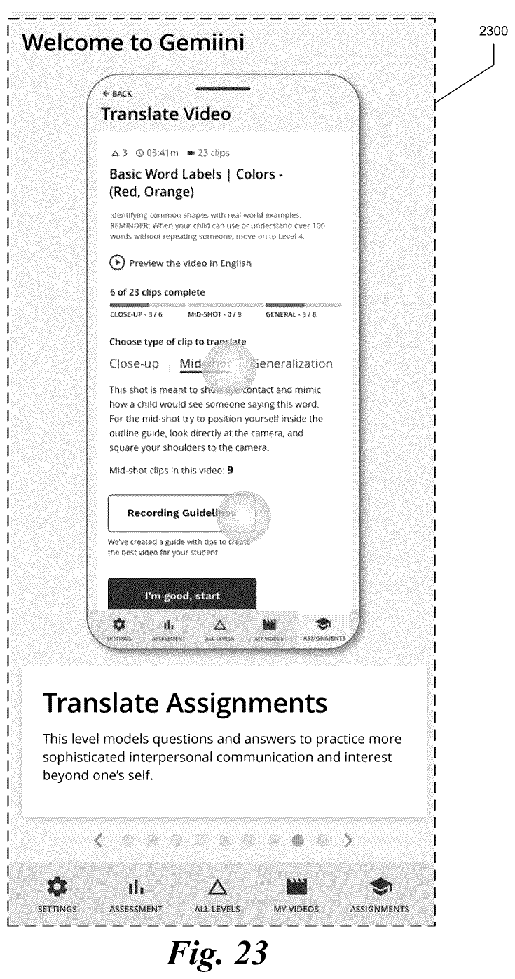

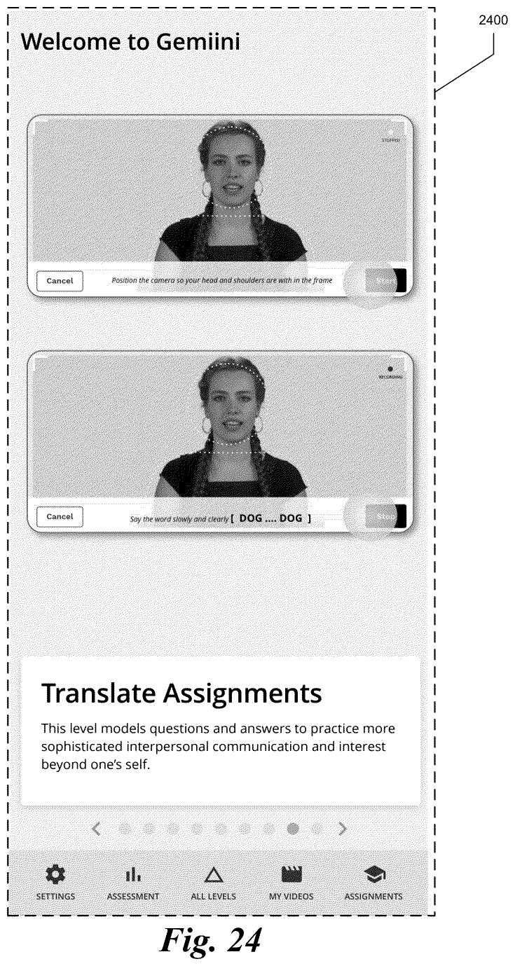

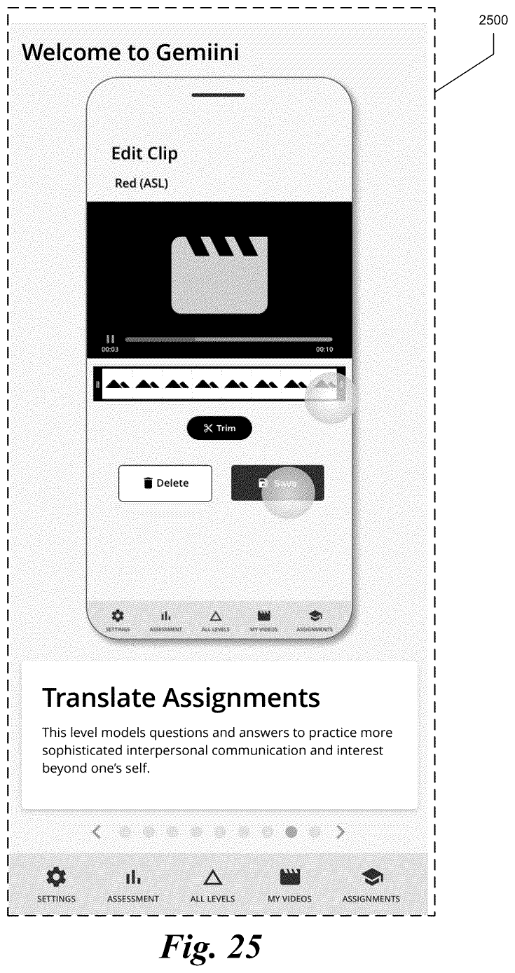

FIGS. 20-25 depict example user interfaces user interface 2000, user interface 2100, user interface 2200, user interface 2300, user interface 2400, and user interface 2500 that provide an introduction and tutorial for using the mobile application.

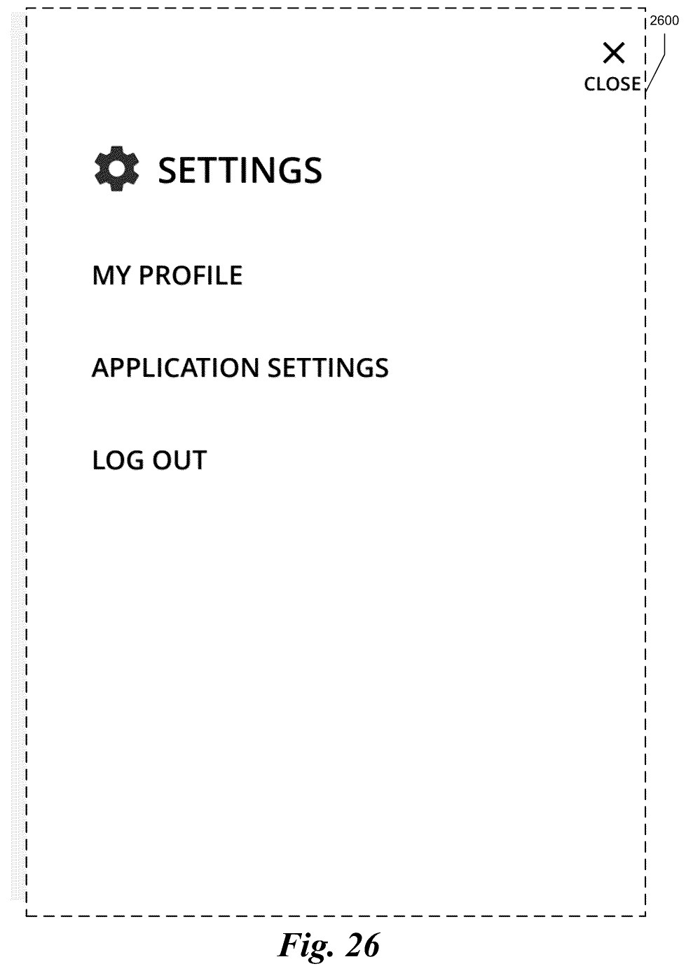

FIG. 26 depicts an example user interface 2600 for configuring profile and application settings.

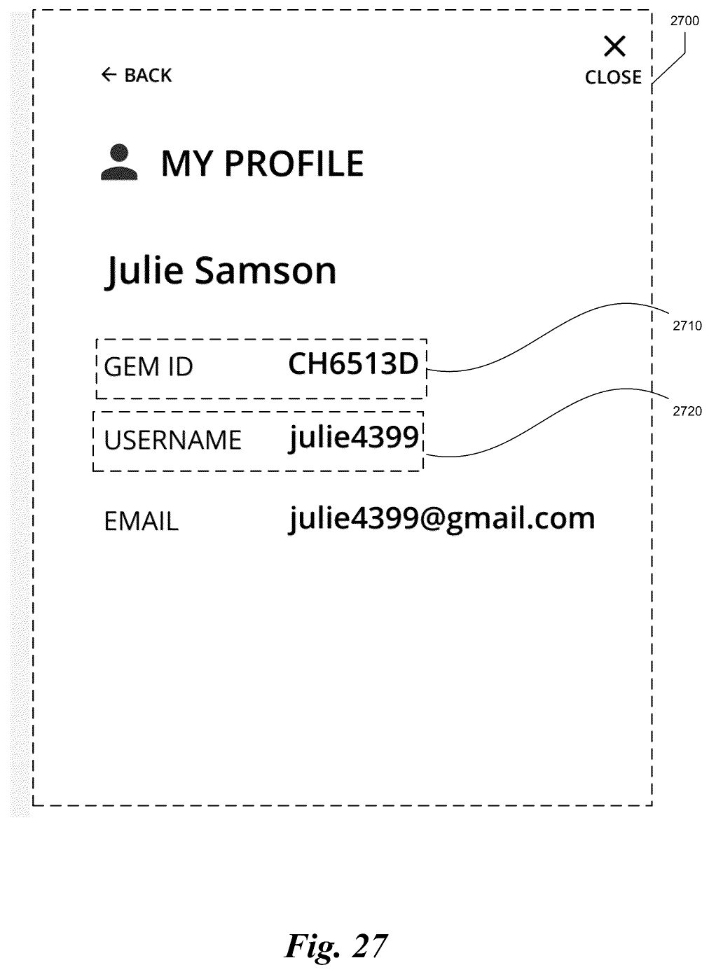

FIG. 27 depicts an example user interface 2700 for configuring profile and application settings. A learned may be assigned an identifier 2710 (e.g., a GEM ID), and a username 2720. The identifier 2710 and username 2720 may be configurable by a user of the mobile application (e.g., a parent, student, teacher, or other individual with access to the mobile application). In some embodiments one or more of the identifier 2710 and the username 2720 may be configurable on the user interface 2700. In some embodiments, the identifier 2710 and/or username 2720 may be configurable at a sign-up or other user interface.

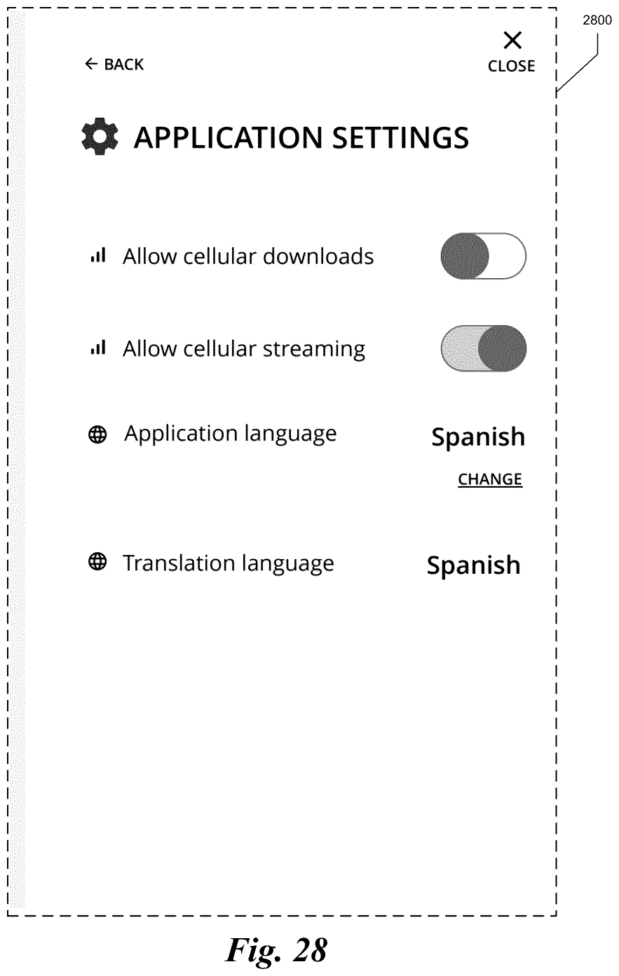

FIG. 28 depicts an example user interface 2800 for configuring profile and application settings.

FIGS. 29-31 depict example user interfaces for gathering biographical characteristics of a user and estimating a level of the user. While the FIGS. 29-31 present examples of biographical information which may be collected, other biographical information may be collected as well, such as by a separate user interface or as part of an existing user interface, for example any information useful for developing lesson plans, modifying lessons, providing feedback, etc. may be collected.

FIG. 29 depicts example user interface 2900, which requests an age range selection indicating the age range containing the age of a user or student from a list of age ranges 2905. The list of age ranges 2905 depicted in the user interface 2900 comprises options for “Teenager” and “Adult.” Teenager may include any age from 13-19, or may be limited based on the other options presented (e.g., if an age range option exists for 10-13, then the “Teenage” category may include only individuals age 14-19). Adult may include any age over 18. In some examples, the request for an age range may instead be a request for the student's specific age (e.g., a list of ages 0-20 may be presented individually to be selected from). While the present example user interface 2900 allows selection of an age range by a radio button, alternative selection presentations may be used. For example, a selection presentation may be a drop-down list, a scrollable table embedded in the user interface 2900, a box allowing a user to enter the student's age, and the like. The information received from the user interface 2900 may be used by, for example, a machine learning model as input to determine lesson plans, adapt individual lessons to a student, generate or adapt testing material, and/or to perform any other teaching or planning function of the machine learning model.

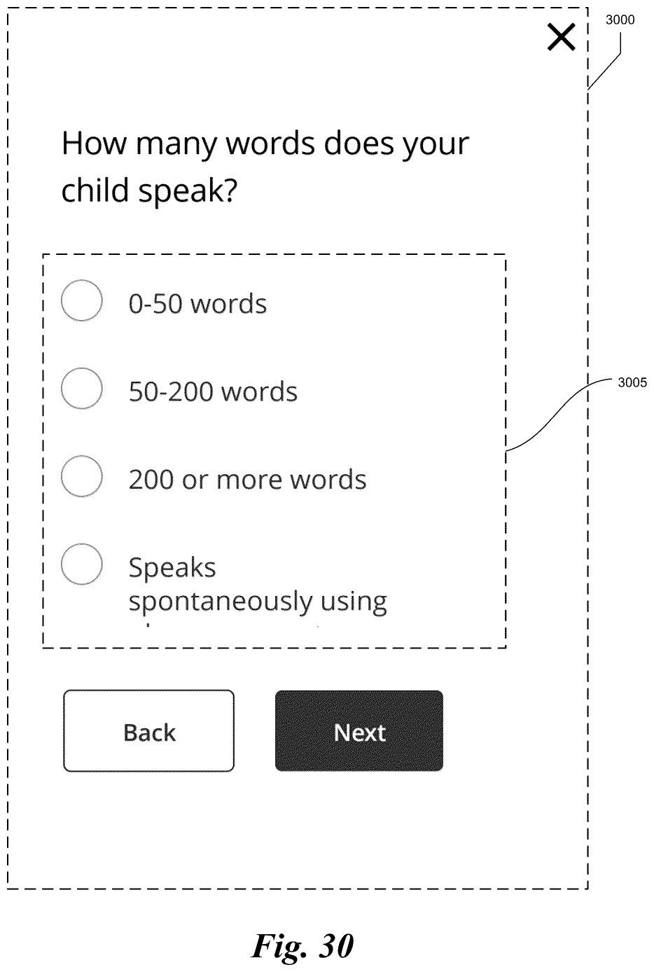

FIG. 30 depicts example user interface 3000, which requests a selection indicating a number of words spoken by the student from a list of word ranges 3005. In some embodiments, the ranges of words may differ from that in the example user interface 3000, for example the ranges may include more or fewer words. As described above with reference to user interface 2900, while radio buttons are presented here, other input methods may be used to allow user input of the requested information. The information received from the user interface 3000 may be used by, for example, a machine learning model as input to determine lesson plans, adapt individual lessons to a student, generate or adapt testing material, or to perform any other teaching or planning function of the machine learning model.

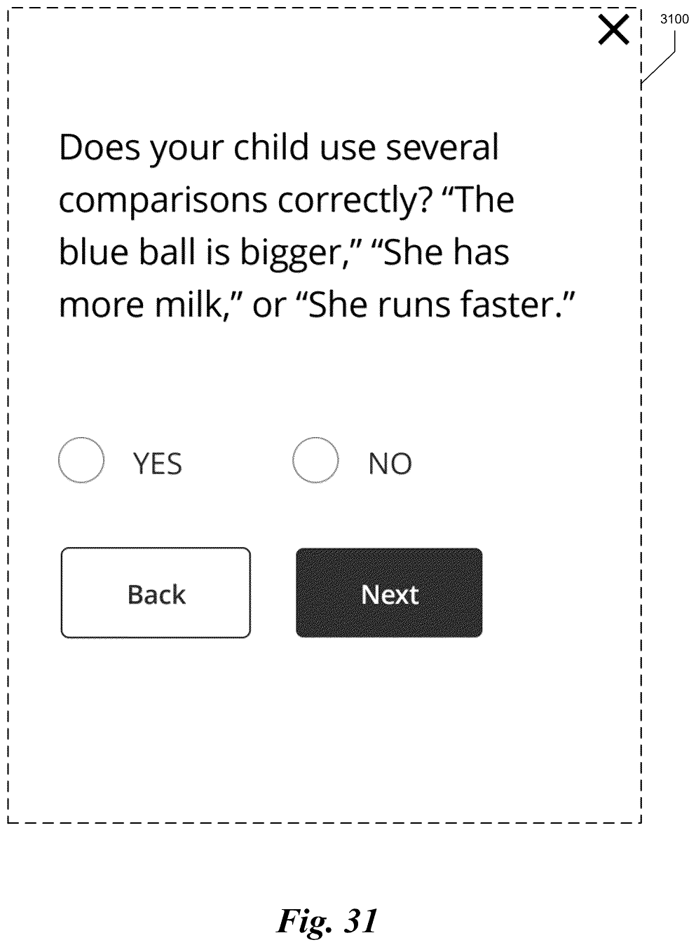

FIG. 31 depicts example user interface 3100, which requests a selection indicating whether a child uses comparisons correctly. While three comparison examples are presented in the example user interface 3100, more or fewer comparison examples may be used, and different comparison examples may be used.

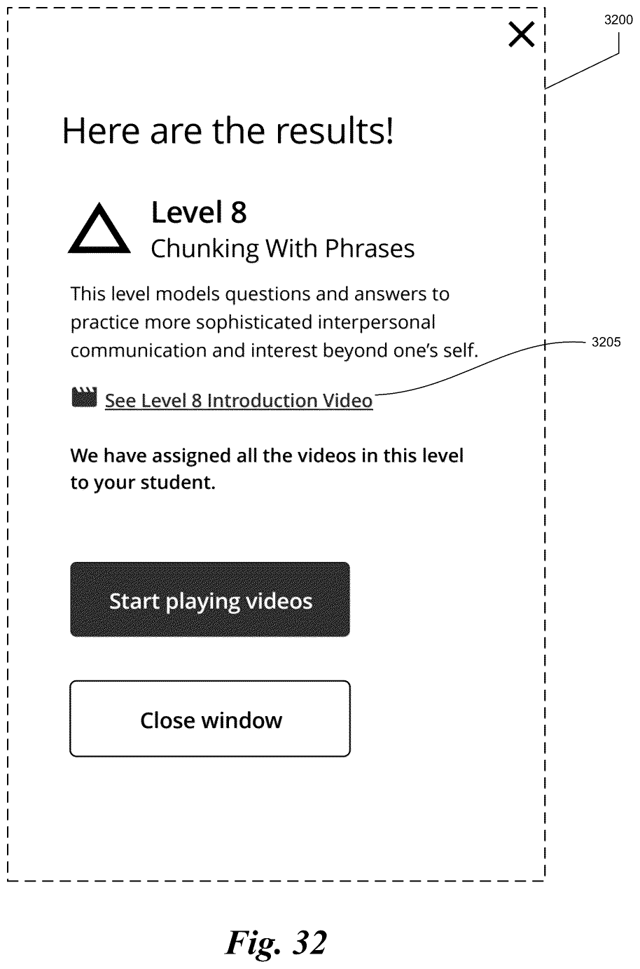

FIG. 32 depicts example user interface 3200, which indicates a material level associated with the student's educational attainment and needs. In some embodiments, a link 3205 may be provided for the student, teacher, adult, or other user to view introductory information (e.g., an introductory video) associated with the material level which has been assigned to the student.

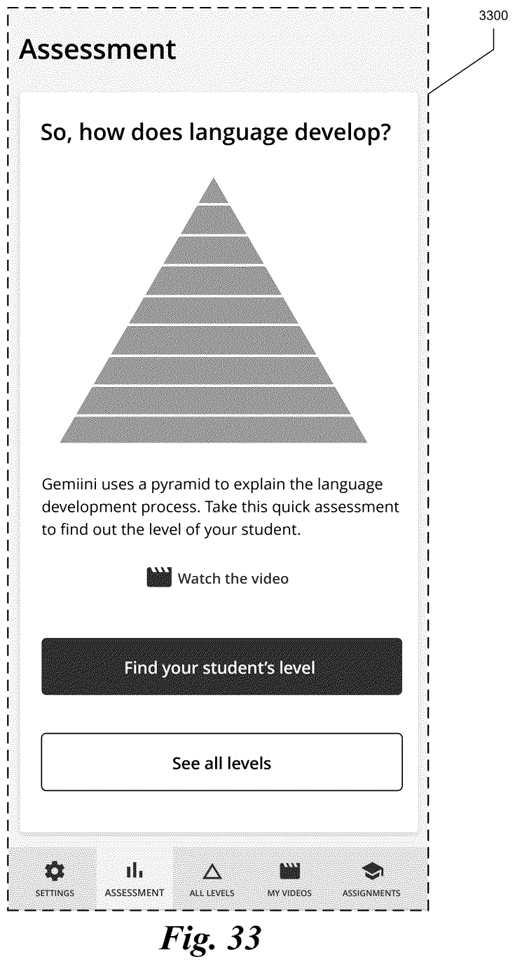

FIG. 33 depicts example user interface 3300, indicating to a user the purpose of an assessment and directing the user to conduct an assessment of the student using the mobile application. In some embodiments, the user may be provided an opportunity to view all potential levels of the learning system.

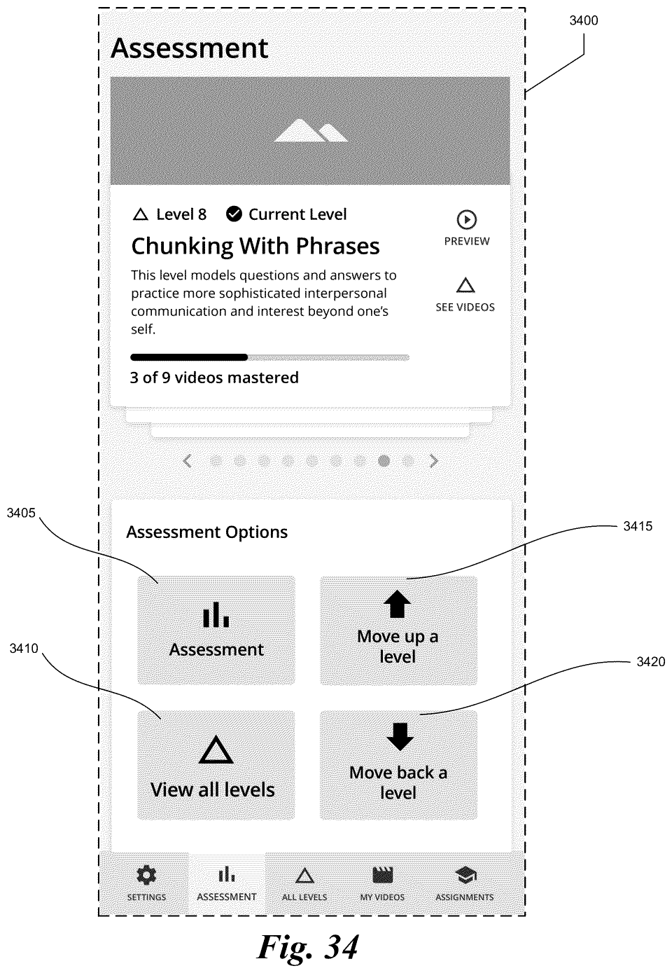

FIG. 34 depicts example user interface 3400 presenting an assessment view for the mobile application. The user may be presented with various options related to the assessment. For example, a button 3415 for moving up an assessment level, a button 3420 for moving down an assessment level. Additionally, a user may be presented with a button 3410 to view all assessment levels, and a button 3405 to view additional assessment information.

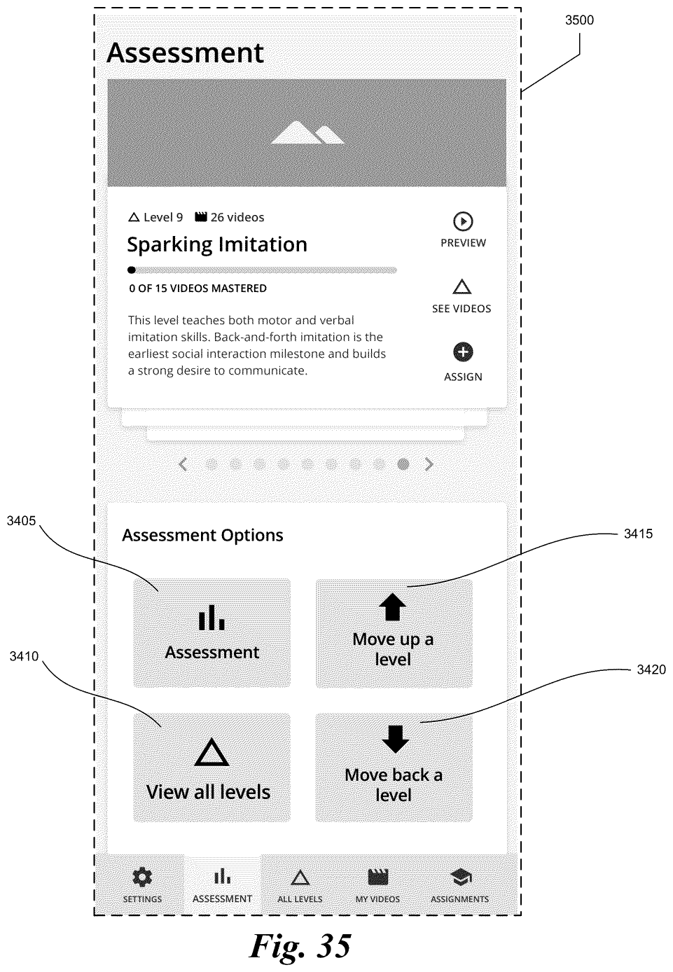

FIG. 35 depicts example user interface 3500, presenting an assessment view associated with a material level different from the material level for the assessment presented in user interface 3400. Material levels may indicate a difficulty level of the lesson material presented to a student, for example Level 9 may present material more difficult than the material presented to a student in Level 8. Additionally, material in s subsequent material level may build on or require an understanding of material in a preceding material level. For example, a first level may present a set of words to a student and assess the student's ability to learn those words, and a second level subsequent to the first may instruct the student on combining the words learned in the first level into sentences (e.g., by teaching grammar of the language being taught).

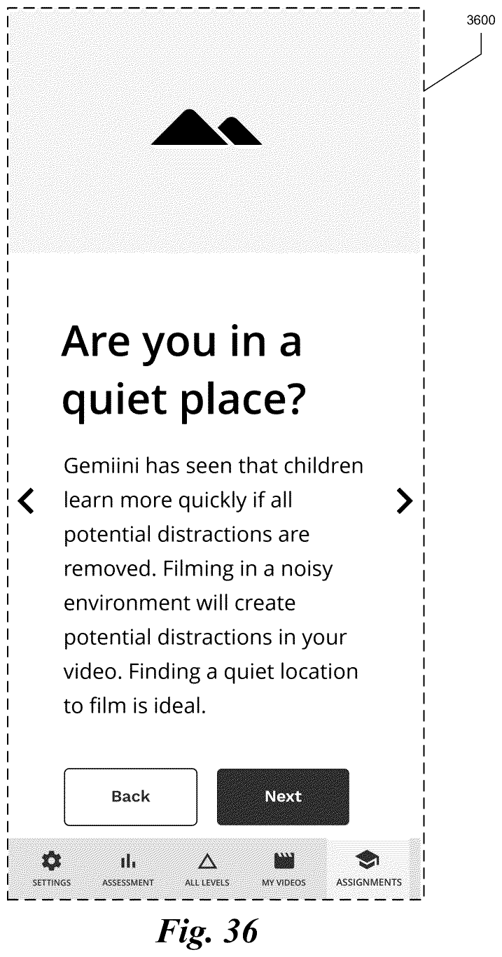

FIGS. 36-40 depict example user interfaces that provide a set of recommendations and instructions to a teacher, parent, or other like individual for capturing one or more video segments. While the instructions presented in FIGS. 36-40 indicate specific instructions, such as recording in a quiet place or adjusting lighting, additional or alternative user interfaces may be presented to instruct a user in a method of video recording. Additionally, while one instruction is presented in each user interface of FIGS. 36-40, a user interface may display more than one instruction, or may present an instruction on one user interface and present a subsequent user interface allowing the user to ensure that they have followed the instruction. For example, a first user interface (e.g., user interface 3600) may instruct a user to ensure they are in a quiet place, and a subsequent user interface may allow the user to measure a sound level to indicate the user has followed the instruction. Additionally, any of the user interfaces presented in FIGS. 36-40 may present more or less information related to the recording of a video lesson, for example additional reasoning for a particular instruction may be presented to the user which may increase compliance with the instructions.

FIG. 36 depicts example user interface 3600 which presents a step of instructing a teacher, adult, parent, educator, or other like individual in a method of recording videos to be used as part of video lessons for a student. The instructions displayed by the example user interface 3600 indicate that the video should be recorded in a quiet location. Additionally, the example user interface 3600 indicates the reason for recording a video in a quiet location, which may serve to encourage the individual recording the video to follow the directions.

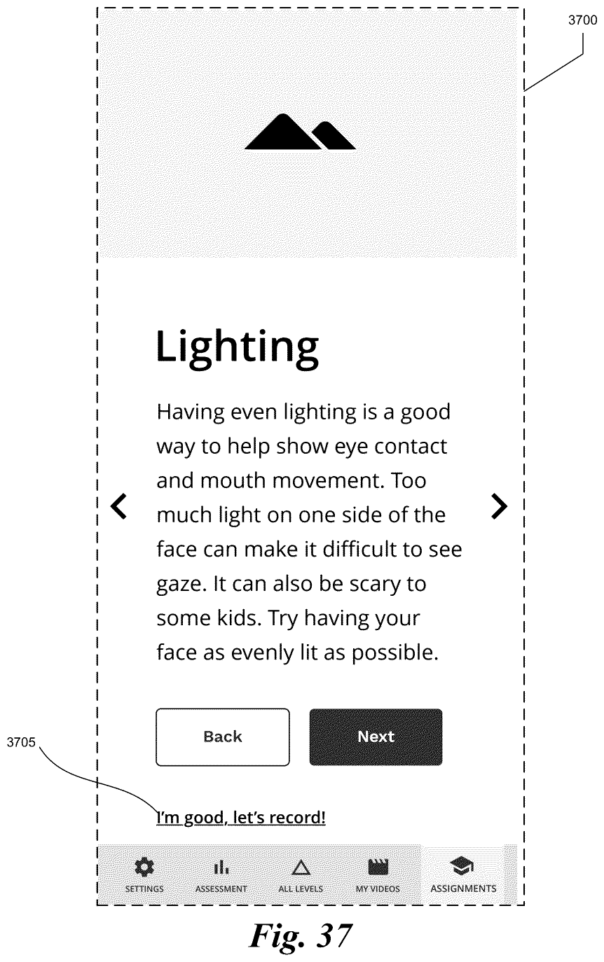

FIG. 37 depicts example user interface 3700 which presents a step of instructing a teacher, adult, parent, educator, or other like individual in a method of recording videos to be used as part of video lessons for a student. In the example user interface 3700 instructions are presented for a lighting arrangement which may improve the ability of a student to focus on, understand, or otherwise learn from the recorded video. In some embodiments, the user interface 3700 may present the user with an option, such as a link 3705, to skip some or all of the instructions for recording a video. Allowing the user to skip some or all of the instructions for recording a video may be useful when a teacher, parent, or other like individual has previously recorded a video or is recording a series of videos and does not require the instructions to be presented again, advantageously saving the individual recording the video time spent moving through instructions such as when a large number of videos are being recorded by a single individual.

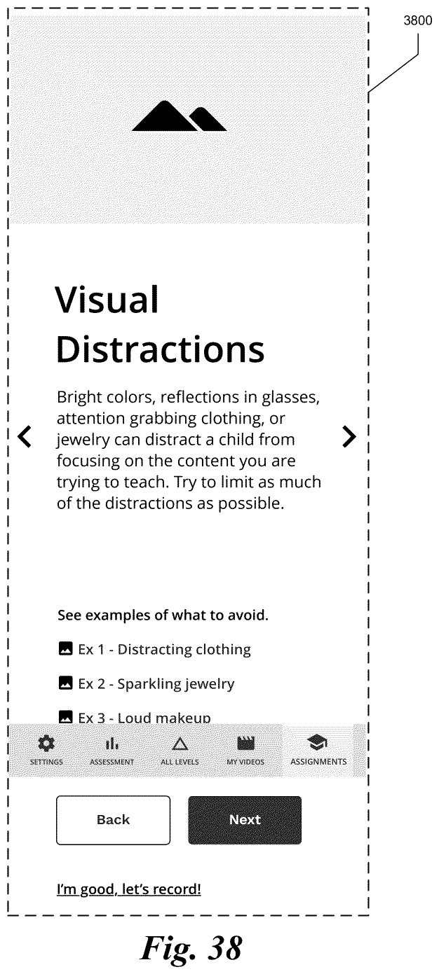

FIG. 38 depicts example user interface 3800 which presents a step of instructing a teacher, adult, parent, educator, or other like individual in a method of recording videos to be used as part of video lessons for a student. In the example user interface 3800 instructions are presented for minimizing visual distractions in the recording. Visual distraction, as indicated by the user interface 3800, may reduce the effectiveness of the video lesson by, for example, distracting the student, potentially making it more difficult for the student to understand or retain the information in the lesson.

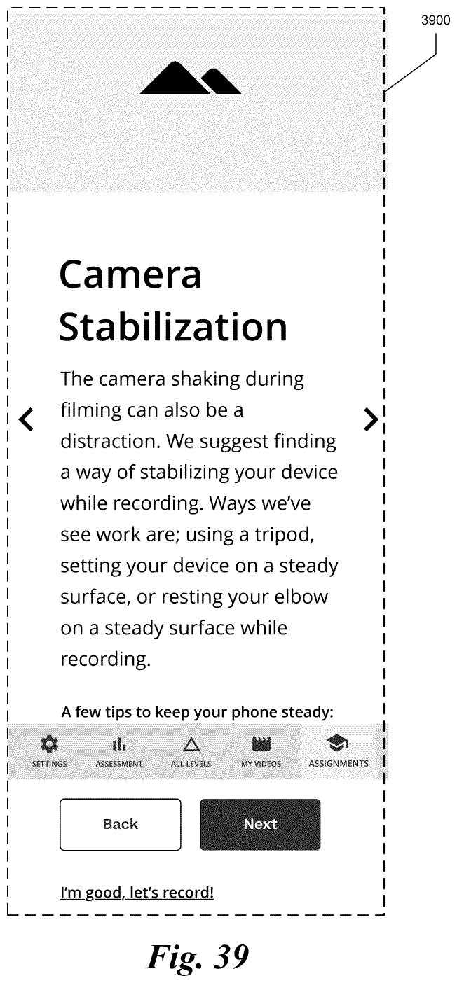

FIG. 39 depicts example user interface 3900 which presents a step of instructing a teacher, adult, parent, educator, or other like individual in a method of recording videos to be used as part of video lessons for a student. In the example user interface 3900, instructions are presented to the user for stabilizing a camera (e.g., a smartphone, webcam, or other visual recording device) being used to record a video lesson. Stabilizing the camera may ensure the video lesson minimizes distractions for a student caused by the focus of the student's attention (e.g., the teacher) moving throughout the lesson.

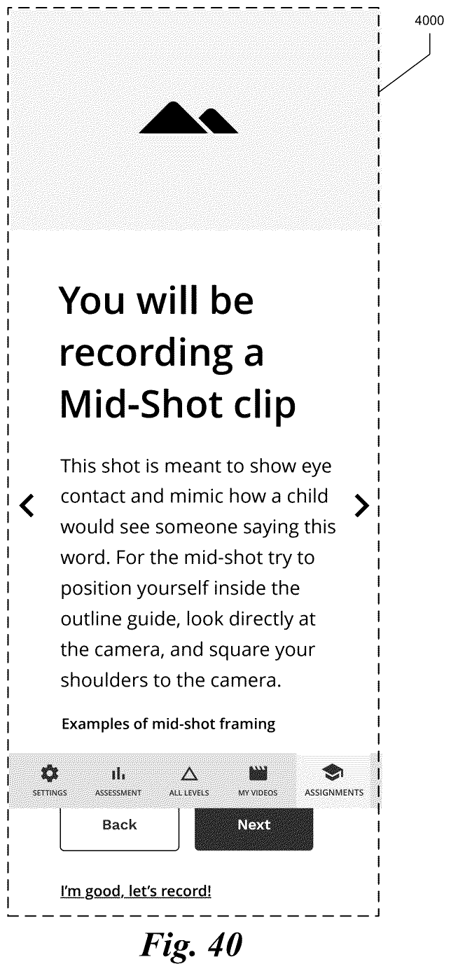

FIG. 40 depicts example user interface 4000 which presents a step of instructing a teacher, adult, parent, educator, or other like individual in a method of recording videos to be used as part of video lessons for a student. The example user interface 4000 provides information about the type of video the user will record. Information is presented indicating the style, purpose, and effect of the recording style the video will be recorded in. The presented information may be helpful in ensuring compliance with the presented instructions, such as by creating an understanding by the individual making the recording of the purpose of the presented instructions.

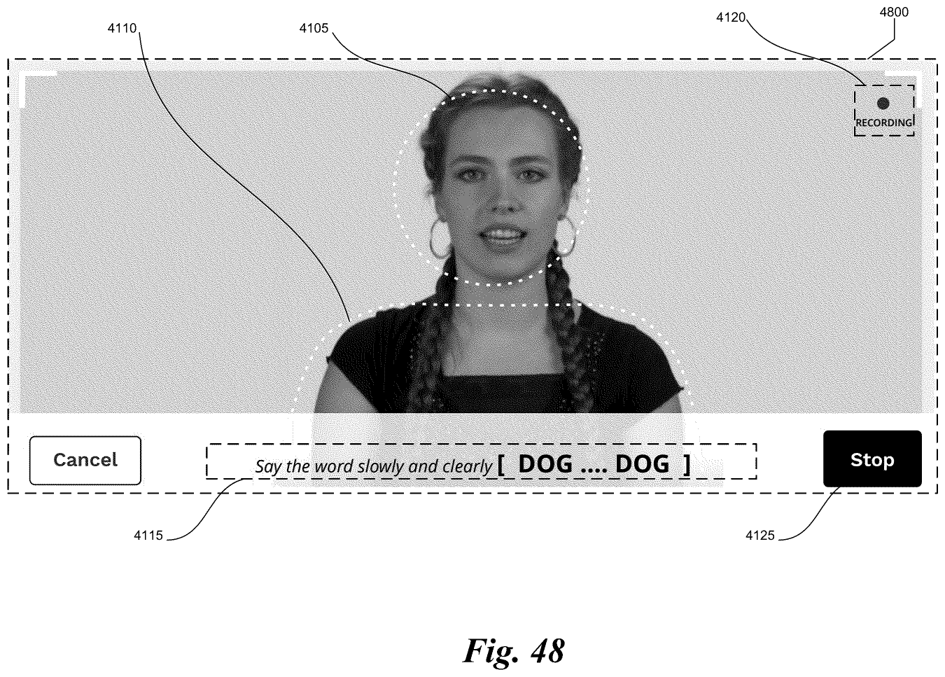

FIGS. 41 and 48 depict example user interfaces that may be displayed when a teacher, parent, or other like individual is attempting to capture the first video segment, which can include an outline for a head position and/or an outline for a shoulders position.

FIG. 41 depicts example user interface 4100 for a video recording interface comprising a head position indicator 4105, a body position indicator 4110, an instruction area 4115, an action button 4125, and a recording status indicator 4120. The head position indicator 4105 indicates a position in the video frame for the user to locate their head while recording the video. The head position indicator 4105 may ensure the head position of one or more teachers or other like individuals is consistent across one or more videos. The body position indicator 4110 indicates a position in the video frame for the body of the user recording the video. The example user interface 4100 indicates a position for the shoulders of the user recording the video. In some embodiments, the body position indicator 4110 may indicate a position for more of the user's body than shown in user interface 4100, or different parts of the user's body (e.g., hands, arms, etc.). The instruction area 4115 presents instructions to the user recording the video instructing the user in the position for recording. Additional or alternative instructions may be presented in the instruction area 4115, the instructions presented in the instruction area 4115 may change during the recording process (e.g., one set of instructions may be presented before recording, and a second set of instructions different from the first may be presented when the recording is active). In some embodiments, a script or other text to be read by the user recording the video may be presented in the instruction area 4115 before, during, or after (e.g., when multiple videos will be recorded) the current video has been recorded. The recording status indicator 4120 indicates the current recording status of the mobile application. The recording status indicator 4120 may indicate, for example, the mobile application has stopped recording (as shown in FIG. 41), the mobile application is currently recording, or a countdown to when the recording of the video will begin. The action button 4125 allows the user to transmit a start indication to the mobile application representing an intention to begin recording the video. The mobile application may respond to the indication through the action button 4125 to start recording by beginning the recording of the video, changing the recording status indicator 4120, or taking another action related to beginning the recording of a video. As seen below in relation to FIG. 48, the action button 4125 may become a stop button allowing the user to send to the system a stop indication when a recording should be stopped. The action button 4125, in some examples, may present other actions the user may take related to the recording of a video. In some embodiments, the action button 4125 may not be presented, instead a countdown or other indication may be presented to the user indicating the mobile application will initiate recording of the video on its own.

FIG. 48 depicts an example user interface 4800 comprising a head position indicator 4105, a body position indicator 4110, an instruction area 4115, an action button 4125, and a recording status indicator 4120. The head position indicator 4105, as above, indicates a position for the user's head. In some embodiments, the mobile application may indicate when the user's head is outside the head position indicator 4105 or positioned to face a direction other than the indicated direction for recording the video, for example by changing the color of the head position indicator 4105 or presenting an alert on the user interface 4800. The determination the user's head is not in the indicated position may be performed by, for example, a machine learning model configured to detect a head position or head pose direction. As above, the body position indicator 4110 indicates the position for the user's body, and like the head position indicator 4105 may be used to indicate when the user's body is not in a correct position or pose direction. The determination the user's body is not in the correct position may be performed by, for example, a machine learning model configured to detect a body position or body pose direction. The recording status indicator 4120 indicates the mobile application is currently recording, and as above may be used to indicate other information related to the recording. The instruction area 4115 in the user interface 4800 presents instructions for the user indicating the words which should be spoken for the recording (e.g., a script, or a pronunciation), and how the words should be spoken. In some embodiments, the instruction area 4115 may indicate a pronunciation for the word or words to be spoken in the recording. The action button 4125 presents the user with the ability to indicate to the mobile application the recording should be stopped.

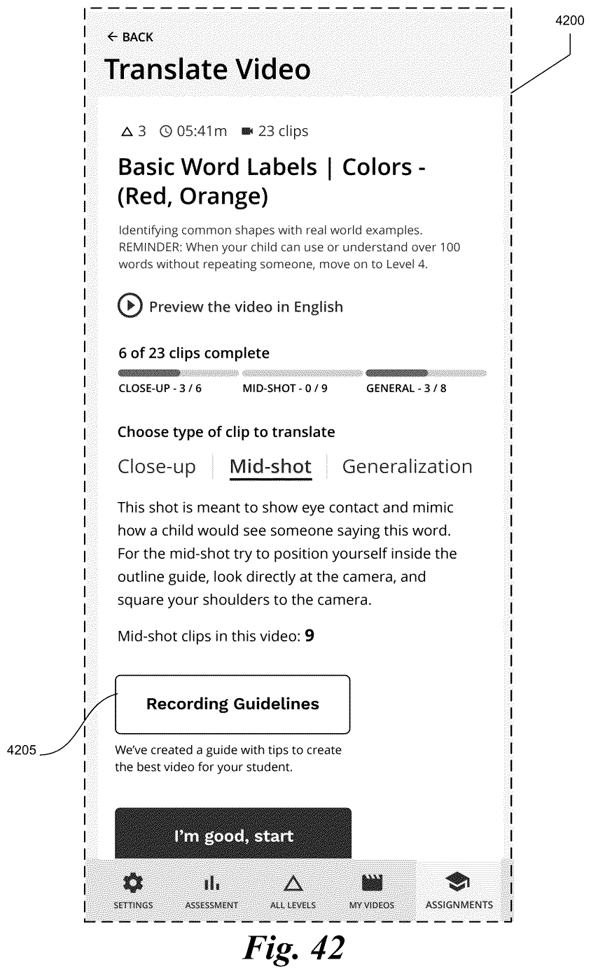

FIG. 42 depicts an example user interface 4200 that indicates a number of different types of video segments that have been completed in a particular category and/or for a particular item. Various categories of video segment may be used by the system, and presented by the user interface 4200. For example, mid-shot and close-up style videos. The user may also be presented with an option, for example button 4205, to request from the mobile application a set of guidelines or instructions for creating a video segment in the indicated style for educating a student (e.g., the user interfaces presented in FIGS. 36-40).

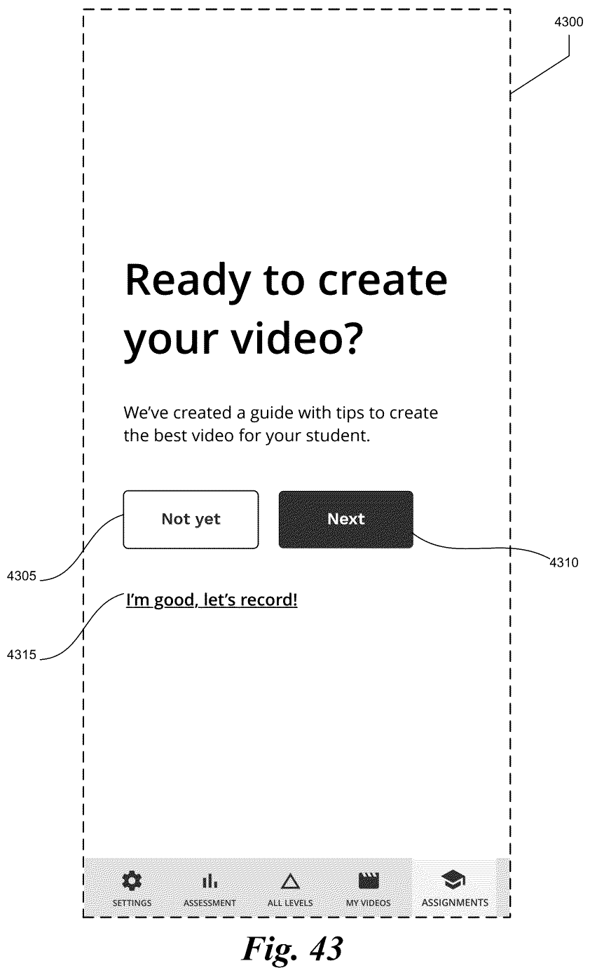

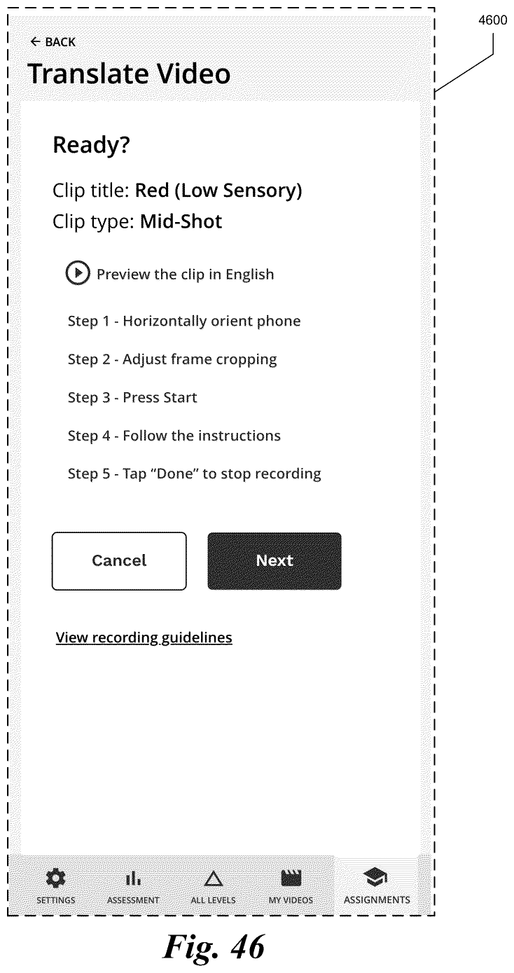

FIGS. 43-44 and 46 depict example user interfaces that provide instructions to a teacher, parent, or other like individual for capturing one or more video segments.

FIG. 43 depicts example user interface 4300 including button 4305 and button 4310. The user interface 4300 requests from the user an indication that the user is ready to record a video segment. The user may indicate, by button 4305, that the user does not intend to record a video and indicates a request from the user to return to another element of the mobile application. The user may indicate, by button 4310, the user's intent to review the instructions for recording a video segment. The user may indicate, such as by link 4315, that the user does not desire to view the instructions, for example when the user has previously recorded a video for the mobile application, and the mobile application may move to a user interface allowing for the video to be recorded (e.g., the user interface 4100 of FIG. 41).

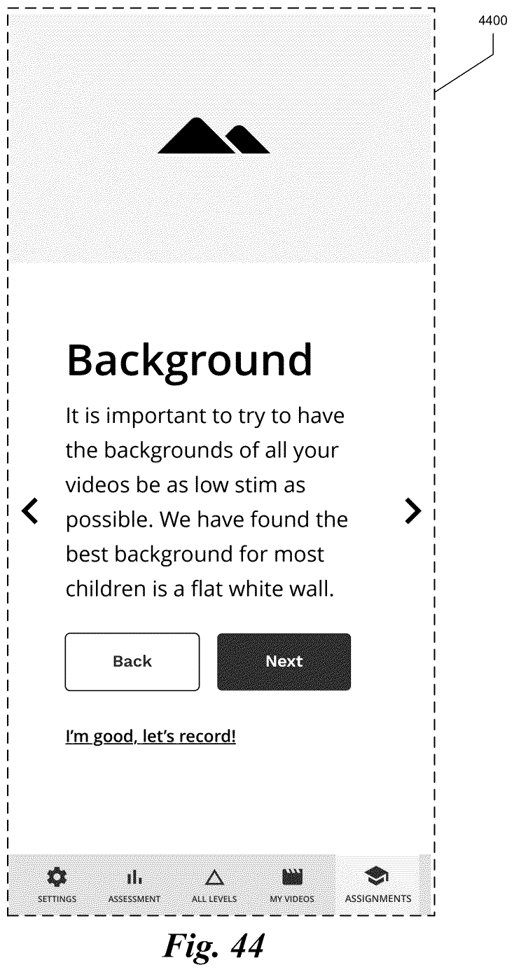

FIG. 44 depicts an example user interface 4400 which presents a step of instructing a teacher, adult, parent, educator, or other like individual in a method of recording videos to be used as part of video lessons for a student. The example user interface 4400 provides information about a background for the user to record the video against. The suggested background may enable a student to better understand, focus on, or otherwise learn from the video segment.

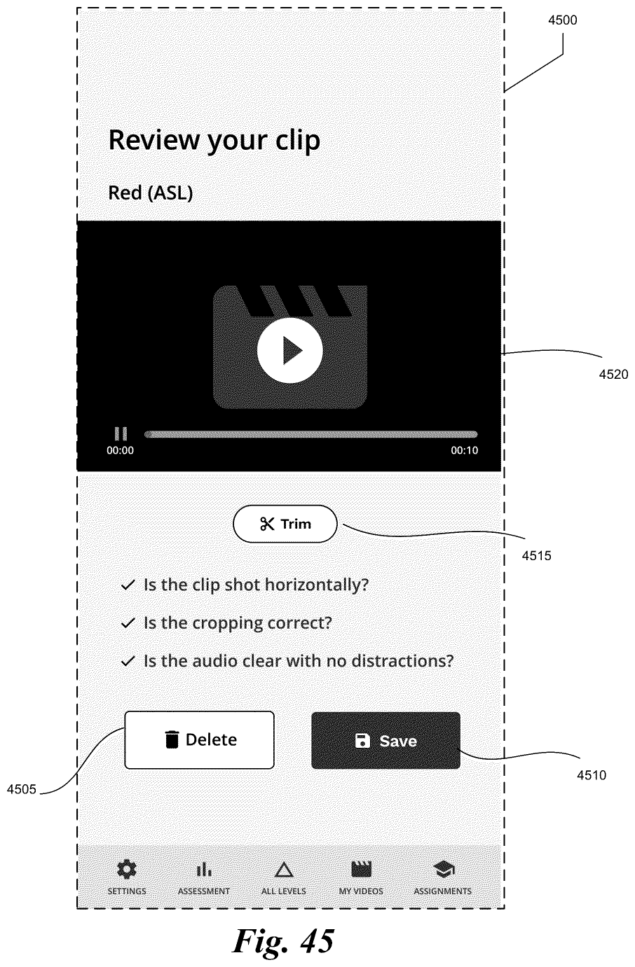

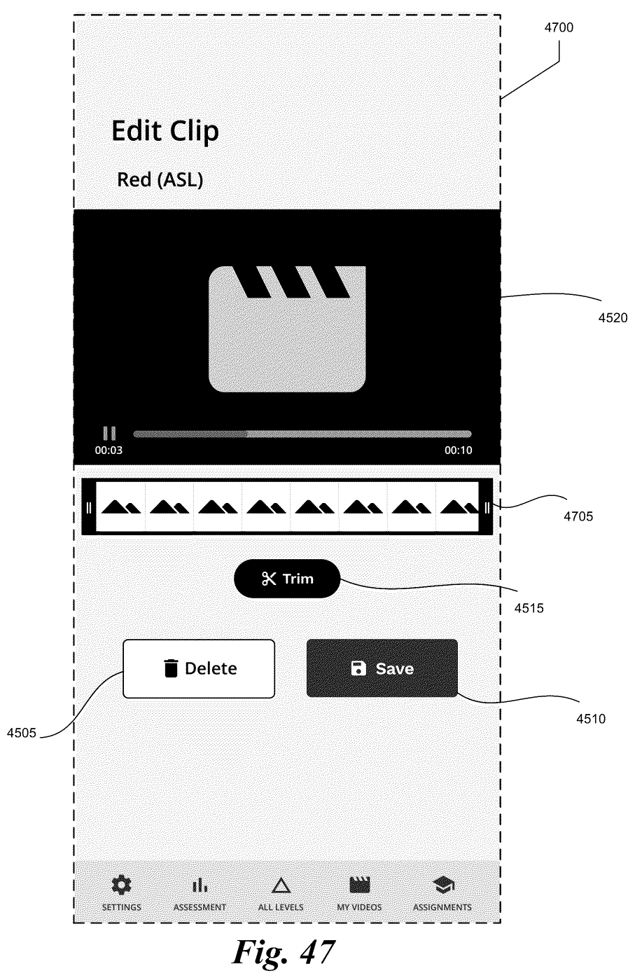

FIGS. 45 and 47 depict example user interfaces that allow a teacher, parent, or other like individual to preview a recorded video segment and/or to edit the video segment (e.g., by trimming portions of the video clip, by cropping portions of the video clip, by adjusting the audio of the video clip, etc.).

FIG. 45 depicts example user interface 4500 which comprises a video player 4520, an option to trim the video using button 4515, an option to delete the video using button 4505, and an option to save the video using button 4510. Using the video player 4520, a user (e.g., a teacher who recorded the video), may review the recorded video. If the user determines the video should be edited, they may interact with the video player 4520 and the button 4515 to indicate that a change should be made to the video by the mobile application. If a user indicates the video should be trimmed, such as by interacting with button 4515, then the user interface may change to the example user interface 4700 depicted in FIG. 47. If a user determines it is not desirable to keep the video, such as when a distraction occurs in the video which may not be removed by trimming the video, they may request the mobile application deletes the video using button 4505. When the user has determined the video should be kept by the mobile application, such as when trimming is complete, or when trimming is not necessary before using the video to instruct a student, the user may direct the mobile application by a completion indication to save the video, for example by using button 4510.

FIG. 47 depicts an example user interface 4700 allowing a user to edit a recorded video in an editing interface. The user interface 4700 may be reached by a user selecting the trim option using button 4515 from the user interface 4500 depicted in FIG. 45. The user may use the video editing bar 4705 to indicate to the mobile application a portion or portions of the video to be included or removed. When a user has completed editing the video, the user may indicate the intention to complete editing by interacting with button 4515, button 4505, or button 4510.

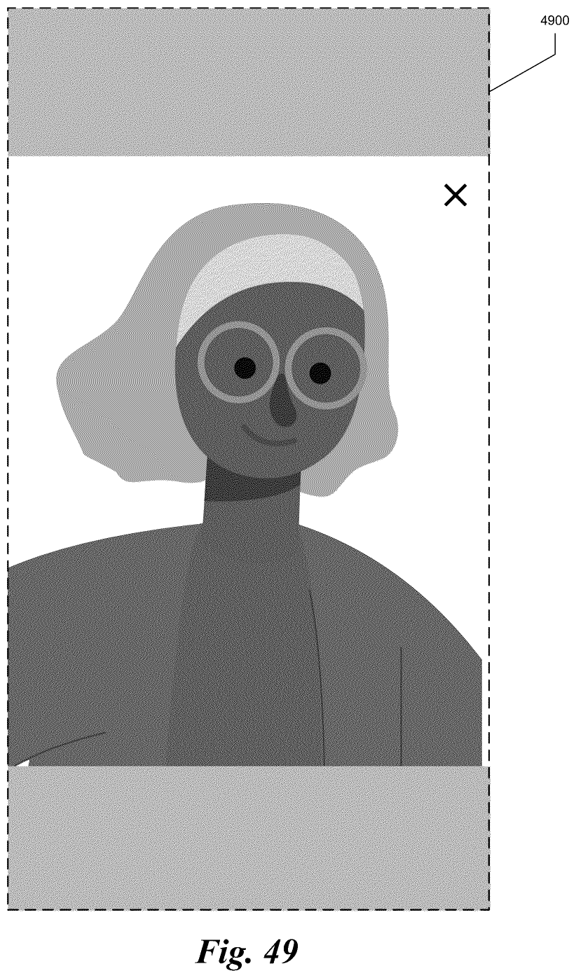

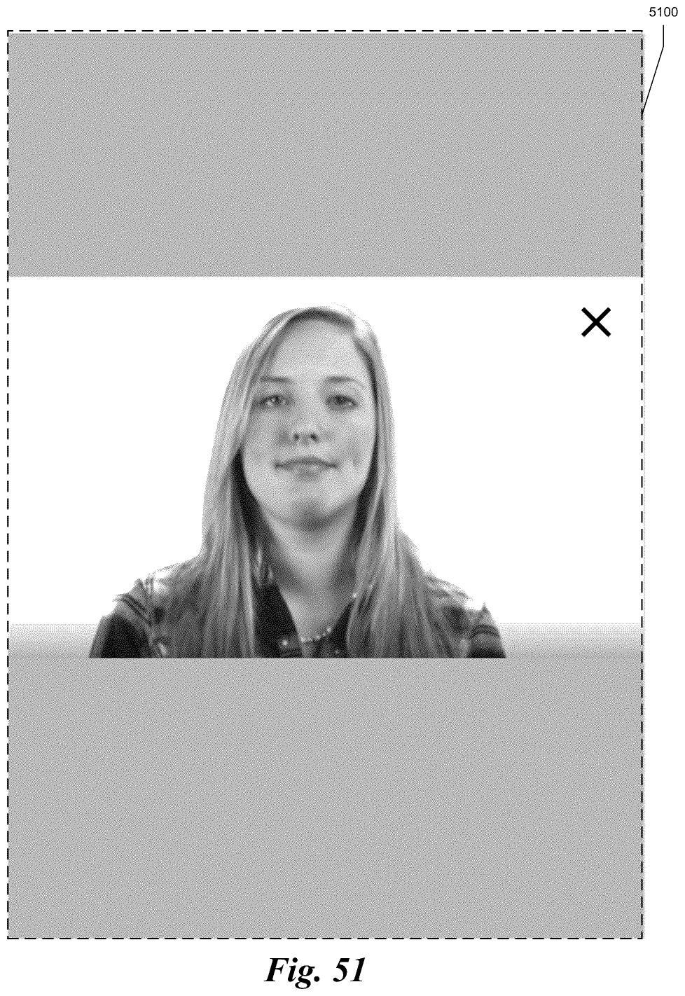

FIGS. 49 and 51 depict example user interfaces user interface 4900 and user interface 5100 depicting a captured video segment.

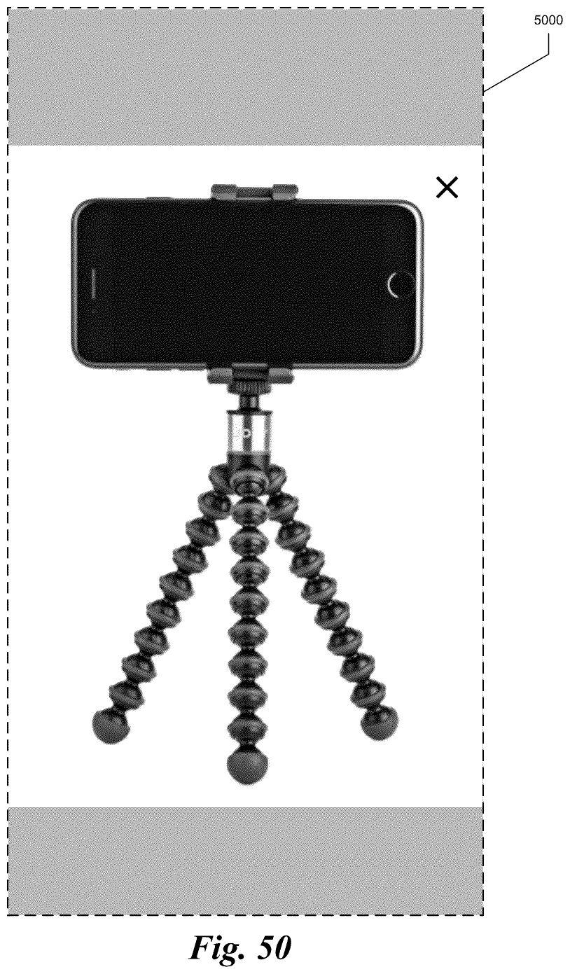

FIG. 50 depicts an example user interface 5000 depicting one method for positioning the user device used to capture a video segment.

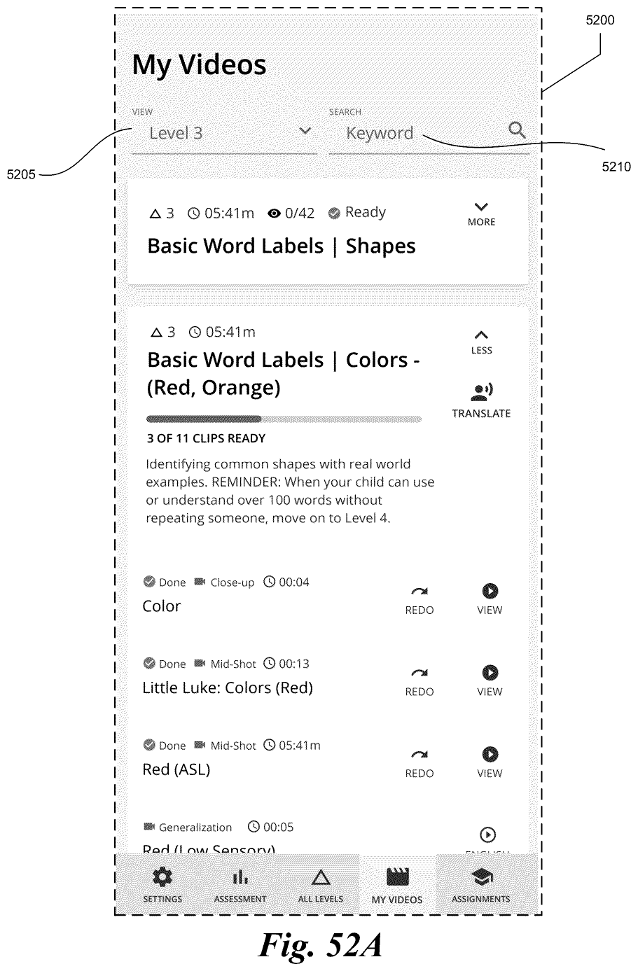

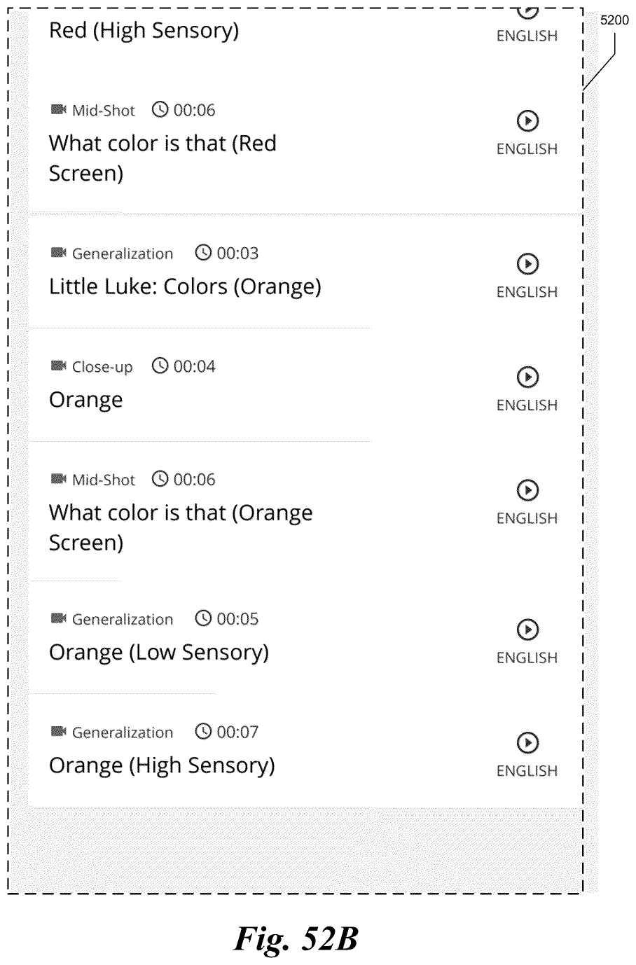

FIG. 52A depicts an example user interface 5200 showing a list of created video segments and further comprising a level selection menu 5205 and a search bar 5210. A user may interact with the level selection menu 5205 to select a level, language, or other category of videos the user wants to see listed in the user interface 5200. As described above, other menu types may be used for the level selection menu 5205 or the search bar 5210 providing other interaction methods (e.g., radio buttons, a list menu, etc.).

FIG. 52B depicts an example user interface showing additional information that is viewable when the user scrolls down in user interface 5200.

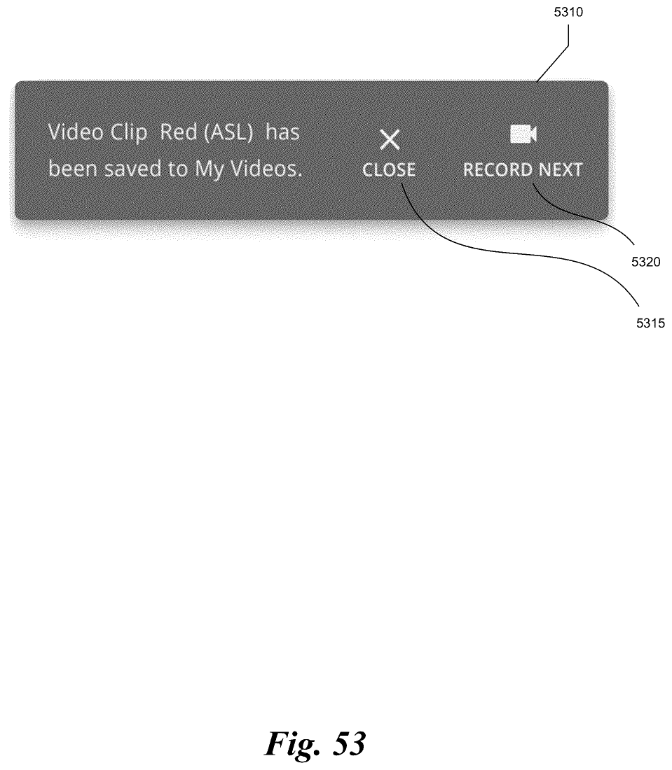

FIG. 53 depicts an example user interface 5310 that indicates when a captured video segment has been saved and further comprising a close button 5315 and a record next button 5320. The record next button 5320 may allow a user to begin recording a next video immediately after saving a current video, and may additionally allow the user to skip the recording instructions presented by the mobile application, for example the instructions shown in FIGS. 43-44.

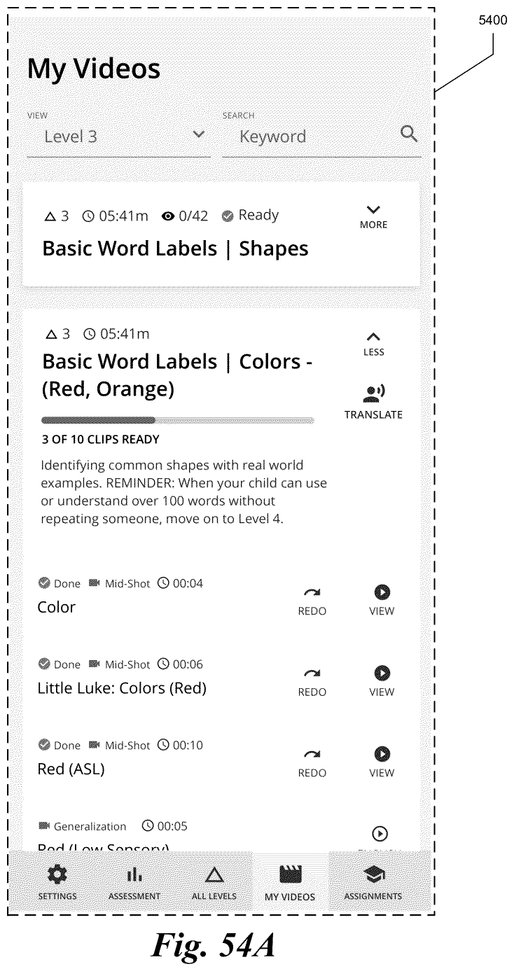

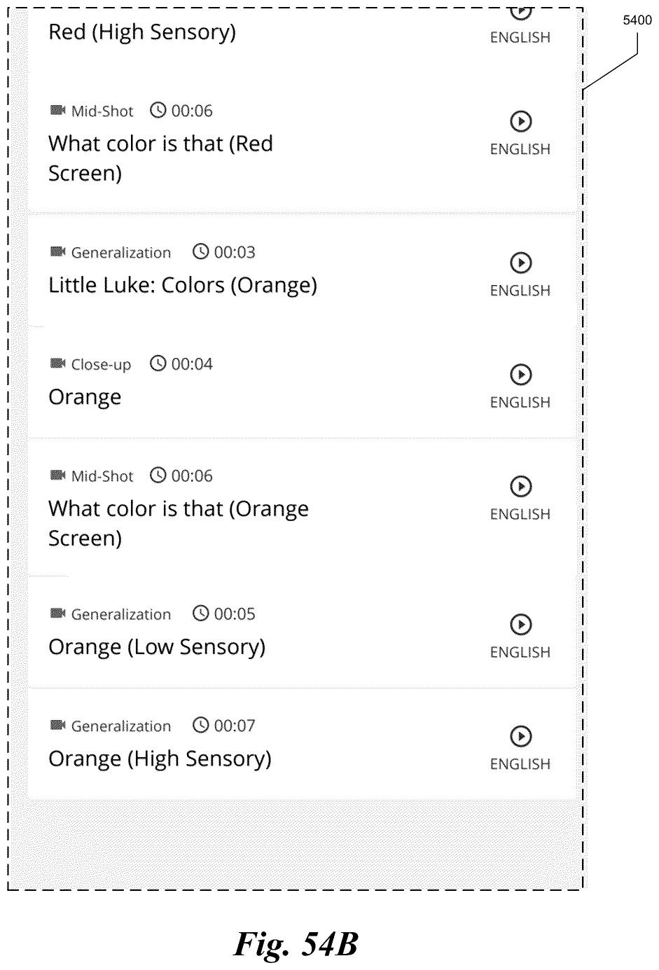

FIG. 54A depicts an example user interface 5400 showing a list of created video segments.

FIG. 54B depicts an example user interface displaying additional information that is viewable when the user scrolls down the example user interface 5400 of FIG. 54A.

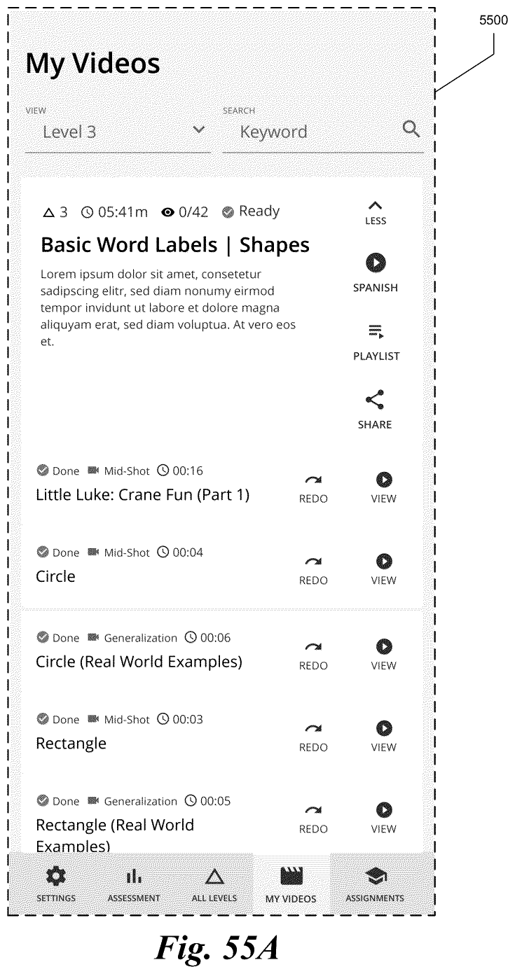

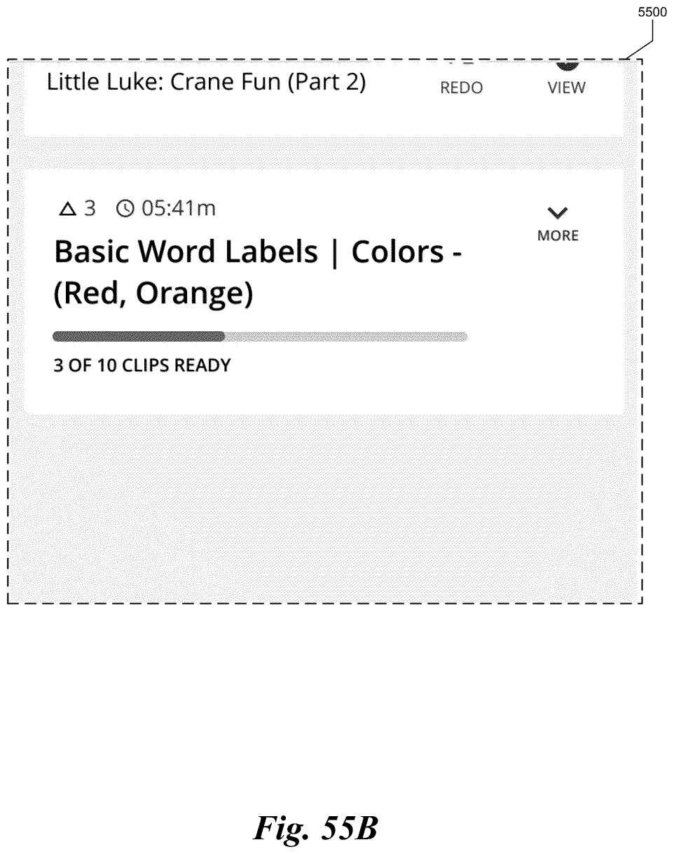

FIG. 55A depicts an example user interface 5500 showing a list of created video segments. FIG. 55B depicts additional information that is viewable when the user scrolls down the user interface 5500.

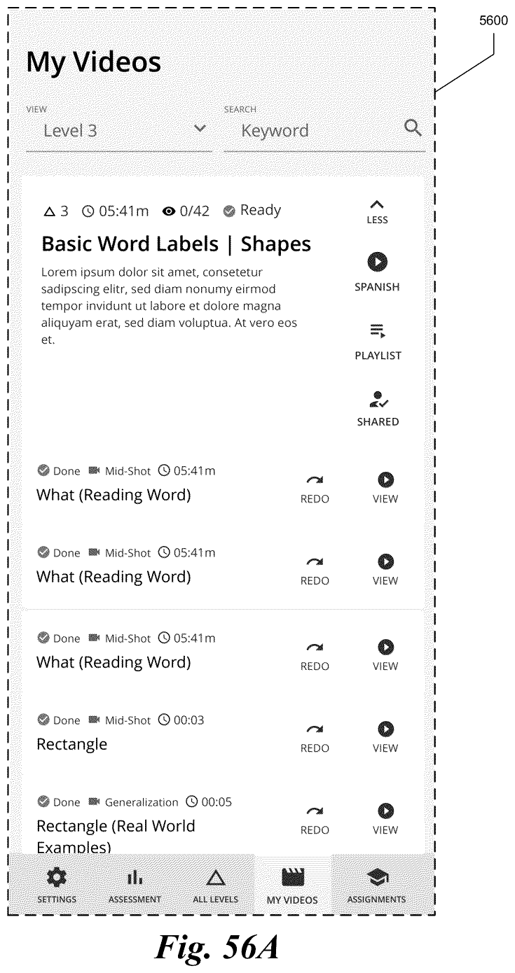

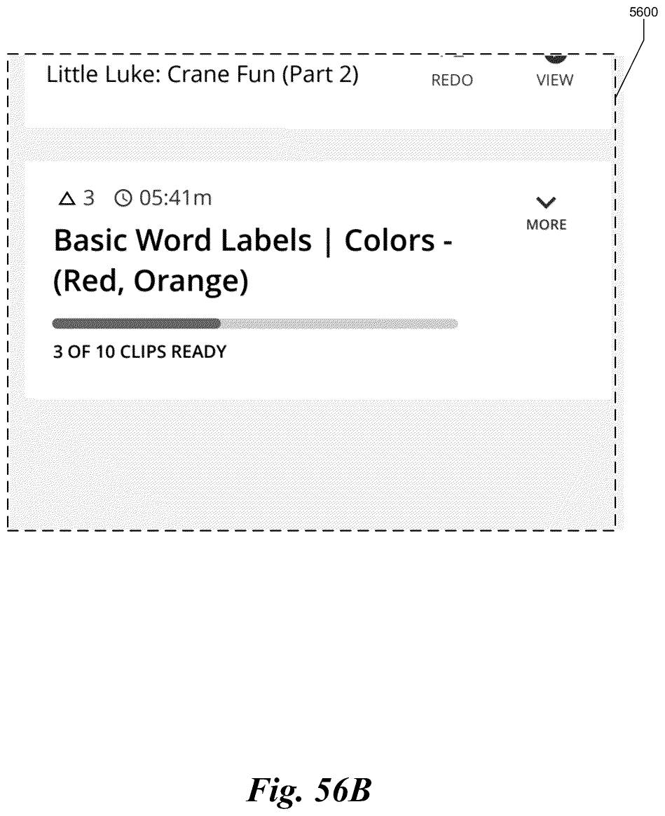

FIG. 56A depicts an example user interface 5600 showing a list of created video segments. FIG. 56B depicts additional information that is viewable when the user scrolls down the user interface 5600.

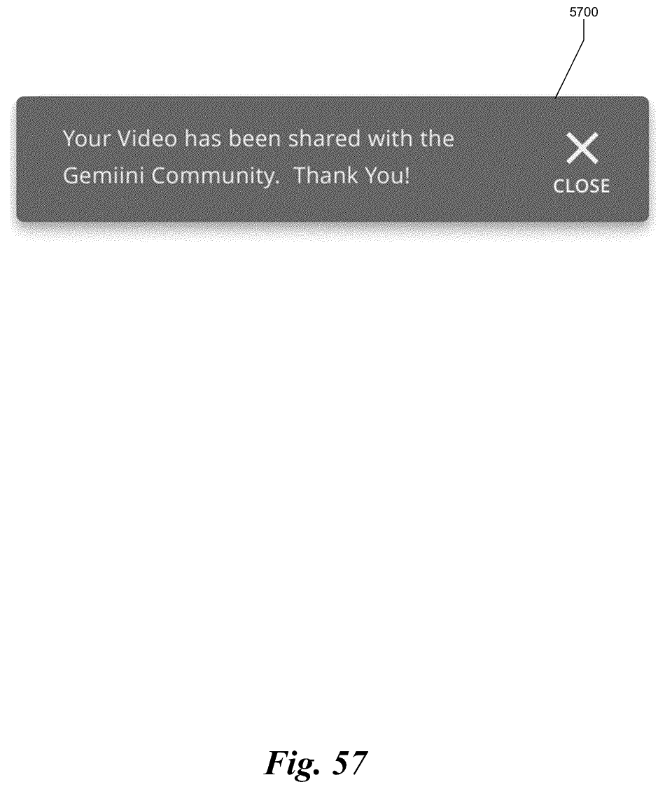

FIG. 57 depicts an example user interface 5700 that indicates when a captured video segment has been shared with the community.

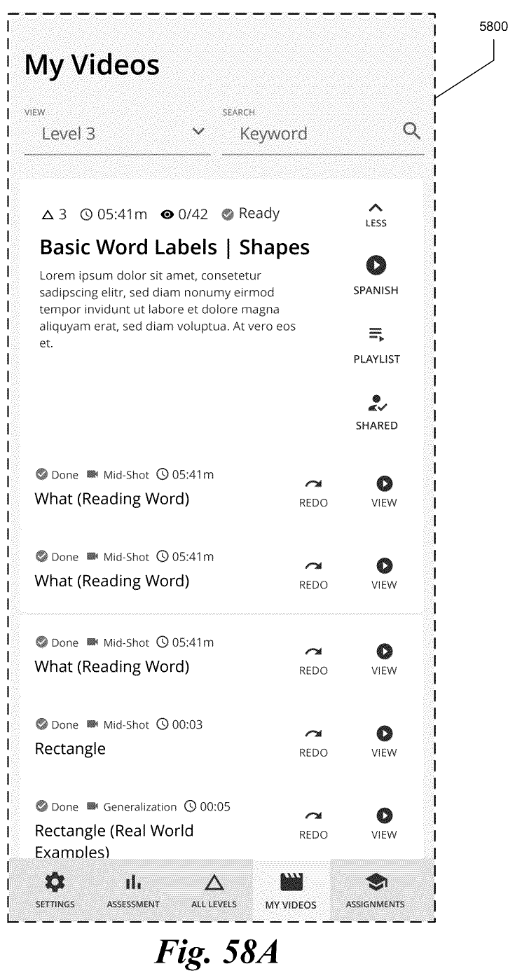

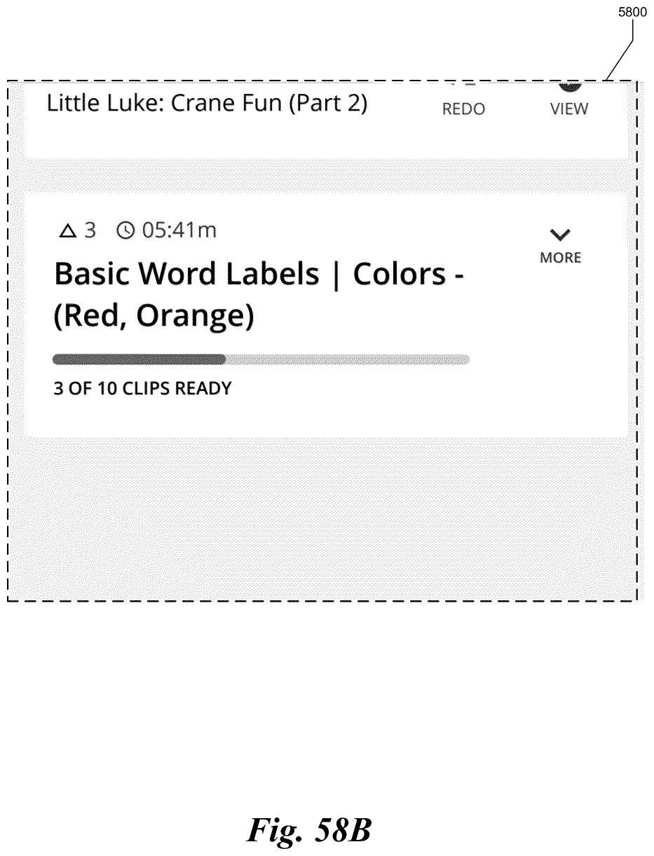

FIG. 58A depicts an example user interface 5800 showing a list of created video segments. FIG. 58B depicts additional information that is viewable when the user scrolls down the user interface 5800.

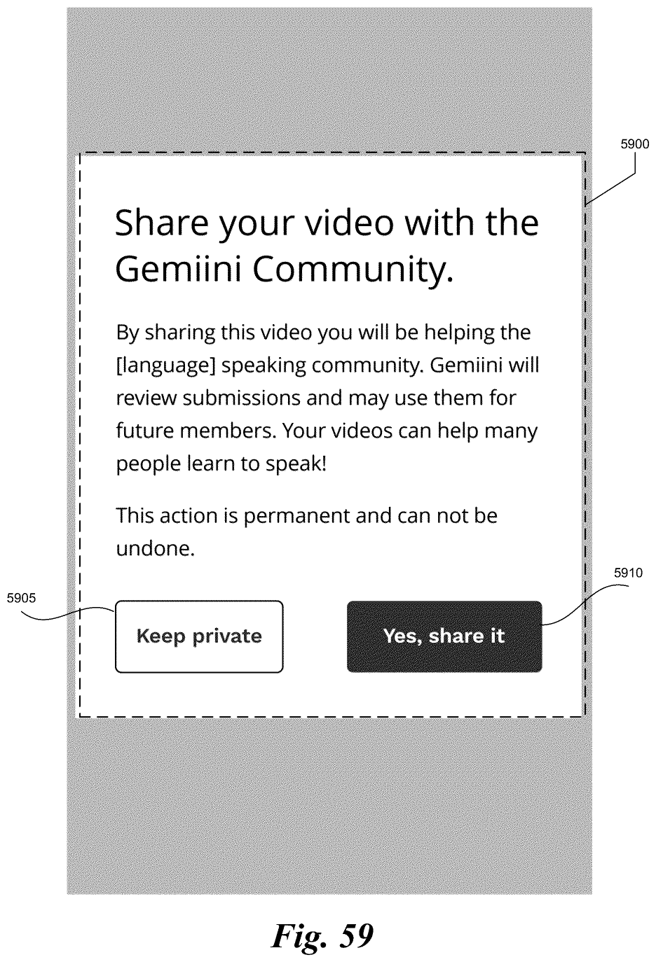

FIG. 59 depicts an example user interface 5900 that allows a teacher, parent, or other like individual to share a video segment with the community and further comprising button 5905 and 5910. The user may interact with further comprising button 5905 to indicate to the mobile application that a video should not be shared to the community. The user may interact with the further comprising button 5910 to indicate to the mobile application that the video should be shared to the community.

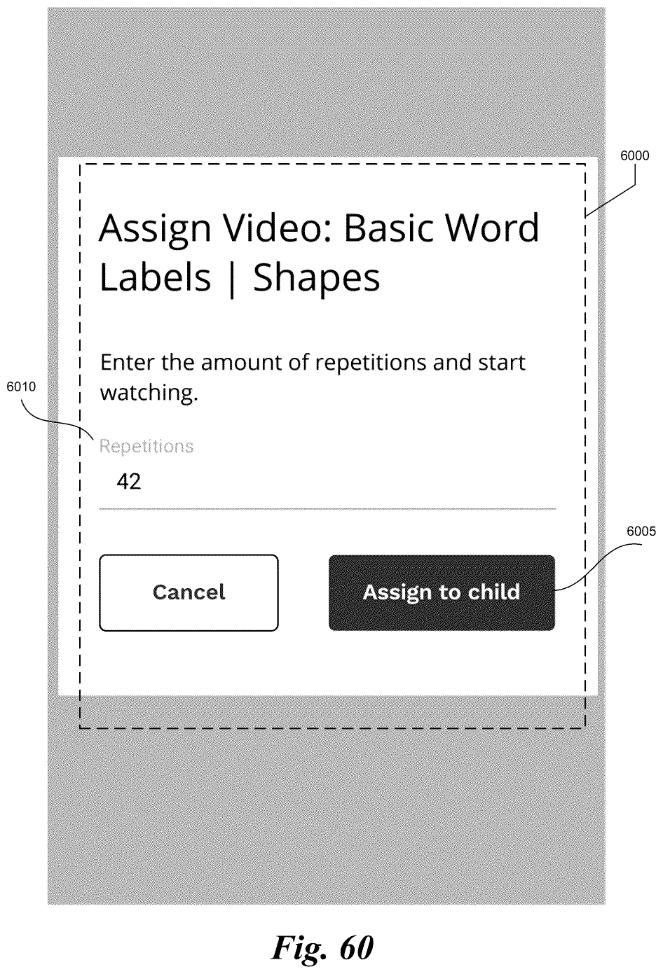

FIG. 60 depicts an example user interface 6000 that allows a teacher, parent, or other like individual to assign a video clip to a user, such as by interacting with button 6005, and/or to indicate a number of times the video clip should be repeated to the user by entering a number of repetitions into input box 6010.

FIG. 61 depicts an example user interface 6100 that allows a teacher, parent, or other like individual to redo the capture of a video segment by interacting with button 6105 to indicate to the mobile application that a video should be deleted. The user may, alternatively, interact with button 6110 to indicate that a video should not be deleted, or re-recorded.

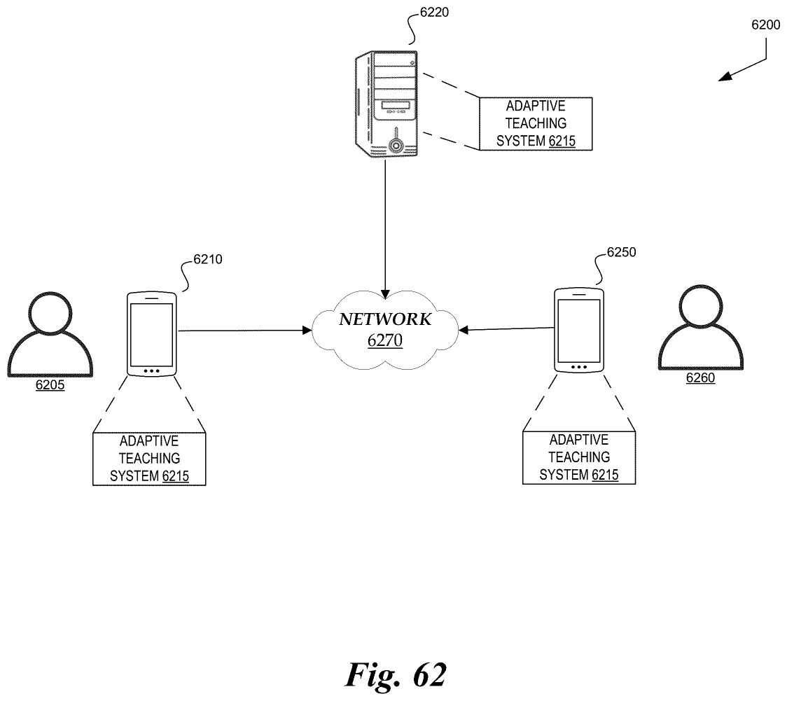

FIG. 62 depicts a block diagram of an example adaptive teaching environment 6200 in which a mobile application operates to instruct a student, in one embodiment. The operating environment, in this example, comprises a student 6205, a student device 6210, a network 6270, a teacher 6260, a teacher device 6250, and a server 6220.

The student 6205 may be any individual using the mobile application to learn. The student device 6210 may be running the adaptive teaching system 6215 locally and may be a mobile device, laptop computing device, desktop computing device, touchscreen monitor in communication with a remote computing device (e.g., a cloud computing environment where the adaptive teaching system 6215 is running), or any other device configured to display video lessons and accept input from the student 6205. In some embodiments, the adaptive teaching system 6215 may run remotely, such as on the server 6220 or in a cloud computing environment. In the remote operation example, input from the student 6205 may be transmitted to the remote device by the network 6270 and videos and other information from the adaptive teaching system 6215 may be transmitted to the student device 6210 via the network 6270.

The teacher 6260 may be a parent, educator, tutor, or any like individual involved in the instruction of the student 6205 using the adaptive teaching system 6215. The teacher device 6250 may be running the adaptive teaching system 6215 locally and may be a mobile device, laptop computing device, desktop computing device, touchscreen monitor in communication with a remote computing device (e.g., a cloud computing environment where the adaptive teaching system 6215 is running), or any other device configured to display instructions (e.g., those shown in FIGS. 43-44 and FIG. 46), record lesson videos, and perform other functions required of the teacher 6260 by the adaptive teaching system 6215. In some embodiments, the adaptive teaching system 6215 may run remotely, such as on the server 6220 or in a cloud computing environment. In the remote operation example, input from the teacher 6260 may be transmitted to the remote device (e.g., server 6220) by the network 6270 and videos and other information from the adaptive teaching system 6215 may be transmitted to the teacher device 6250 via the network 6270.

The server 6220 may be a computing device in communication with the student device 6210 and/or the teacher device 6250 remotely via the network. In some embodiments, there may be a physical connection used where the server 6220 is collocated with the student device 6210 and/or the teacher device 6250.

The server 6220 may be a computing system that is a single computing device, or it may include multiple distinct computing devices, such as computer servers, logically or physically grouped together to collectively operate as a server system. The components of the computing system can each be implemented in application-specific hardware (e.g., a server computing device with one or more ASICs) such that no software is necessary, or as a combination of hardware and software. In addition, the modules and components of the computing system can be combined on one server computing device or separated individually or into groups on several server computing devices.

In some embodiments, the features and services provided by the server 6220 may be implemented as web services consumable via the network. In further embodiments, the computing system is provided by one more virtual machines implemented in a hosted computing environment. The hosted computing environment may include one or more rapidly provisioned and released computing resources, which computing resources may include computing, networking and/or storage devices. A hosted computing environment may also be referred to as a cloud computing environment.

In some embodiments, at least some of the functionality of the operates on each of the student device 6210, teacher device 6250, and the server 6220. In some embodiments, the adaptive teaching system 6215 may run on only one device, for example the adaptive teaching system 6215 may be run only on the server 6220 and communicate information via the network 6270 with the student device 6210 to present information to and receive input from student 6205, and communicate via the network 6270 with the adaptive teaching system 6215 to present information to and receive input from the teacher 6260.

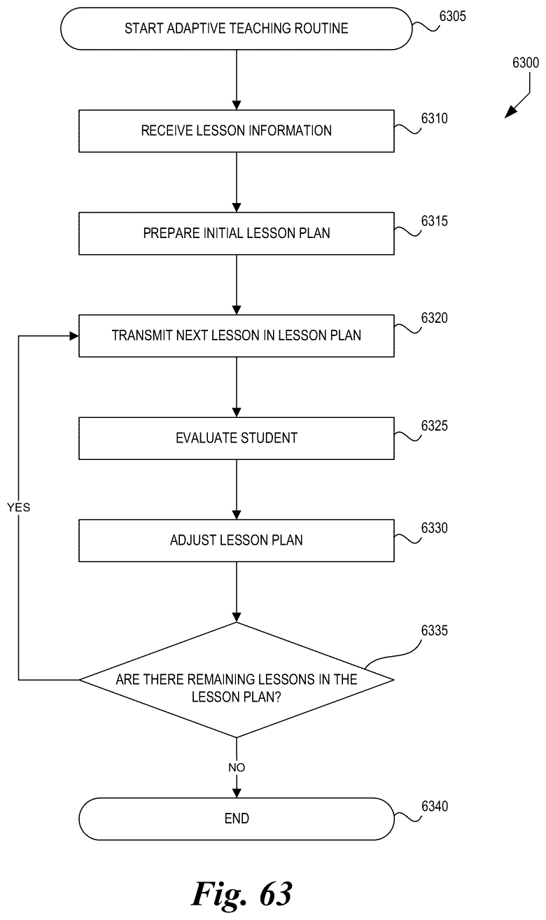

FIG. 63 depicts a flow diagram illustrating an example routine 6300 for an adaptive teaching system 6215 instructing a user. The routine 6300 will be discussed herein in reference to operation on the server 6220, but may occur on any computing device operating as part of the adaptive teaching environment 6200.

Routine 6300 begins at block 6305. In some embodiments routine 6300 begins in response to a request from the student 6205 to initiate a lesson plan. Alternatively, routine 6300 may begin in response to a request from the teacher 6260 to begin the lesson plan. When the routine 6300 has begun, the routine 6300 moves to block 6310.

At block 6310, the server 6220 receives lesson information. In some embodiments, lesson information is received from one or more of the student device 6210, teacher device 6250, or another computing device associated with the adaptive teaching environment 6200 (e.g., a second teacher device, a tutor device, or a like individual participating in the education of the student 6205). Lesson information may comprise, for example, video lesson information (e.g., video clips recorded by a teacher, parent, or like individual using the adaptive teaching environment 6200), text information associated with a lesson, student preference information, student performance information, student learning style, a lesson level indicating the difficulty associated with a lesson or topic, student engagement information, or other information associated with a lesson which may be used to teach the student 6205 (e.g., a lesson time, lesson length, lesson goal, lesson category, lesson difficulty level, lesson language, etc.). In some embodiments, the system will receive student information, such as biographical information entered into the system by the user interfaces of FIGS. 29-31. Student information may, in some embodiments, comprise previous subjects or lessons the student 6205 has completed using the adaptive teaching environment 6200, a student interest of the student 6205, or other information associated with the student 6205 relevant to teaching the student 6205. When lesson information has been received, the routine 6300 moves to block 6315.

At block 6315, the server 6220 prepares an initial lesson plan. The initial lesson plan may be prepared based on, for example, biographical information entered by a user (e.g., the student 6205, the teacher 6260, a parent, a tutor, etc.) such as the information entered in the user interfaces presented in FIGS. 29-35, a time of day, the lesson information received at block 6310, a number of lessons completed previously, a timeframe in which previous lessons have been completed (e.g., five lessons previously completed on the current day), and the like. The initial lesson plan comprises one or more lessons for the student 6205. Preparing the initial lesson plan may, in some embodiments, comprise requesting from a separate device lesson information for one or more lessons in the lesson plan.

In some embodiments, preparing the lesson plan may comprise requesting from the teacher 6260, for example by display of a request on the teacher device 6250, the recording of one or more video clips. The teacher 6260 may then record video clips for one or more of the lessons of the lesson plan as described herein. The adaptive teaching system 6215 may receive one or more video segments from the teacher 6260 in response to the request and incorporate the received one or more video segments into a video for a new lesson. In some embodiments, the adaptive teaching system 6215 may analyze the lessons of the lesson plan, such as by applying the lessons to an artificial intelligence model, to determine the lesson comprises correct information. If the artificial intelligence learning model indicates the lesson contains incorrect information, such as by indicating an incorrect lesson element, the teacher 6260 may be asked to record a video segment which may be combined with correct video segments of the lesson to generate a new lesson, or the teacher 6260 may be asked to record all video segments of the incorrect lesson again to correct the incorrect learning element. A learning element may comprise, for example, a position of the teacher 6260 in the video frame, an extraneous sensory stimuli (e.g., a flashing light behind the teacher 6260), or an incorrect information item (e.g., a word in the video segment that is not expected to be in the video segment, or an incorrect pronunciation). When the lesson plan has been prepared, the routine 6300 moves to block 6320.

At block 6320, the next lesson in the lesson plan is transmitted from the server 6220 to the student device 6210. The lesson may be transmitted via the network 6270, by a physical connection between the student device 6210 and the server 6220, or by any other communication method between the server 6220 and the student device 6210. Transmitting the lesson to the student device 6210 may additionally cause the student device 6210 to begin presentation of the lesson to the student 6205, or may cause the student device 6210 to present a request for confirmation that the student 6205 is prepared to begin the lesson and after receiving such confirmation the student device 6210 may then present the lesson. The lesson may comprise video, audio, text, including instruction and evaluation (e.g., a question testing the material presented in a video lesson). Where the routine 6300 is operating on the student device 6210, block 6320 is optional, and the routine 6300 may instead present the next lesson to the student 6205 directly. When the lesson has been transmitted to the student device 6210 and presented to the student 6205, the routine 6300 moves to block 6325.

At block 6325, the student is evaluated by the adaptive teaching system 6215. In some embodiments, evaluation may comprise determining a student's engagement with the lesson material, such as by recording the level of eye contact with the video by the student 6205, speed of reaction to lesson prompts presented to the student 6205, time spent responding to an evaluation question, or a number of times a video lesson was viewed. In some embodiments, evaluating the student may comprise determining the number of correct or incorrect responses to evaluation questions, a number of times a student correctly or incorrectly answered one or more questions, and the like. Evaluation of the student 6205 may be performed by an artificial intelligence model trained to effectively instruct the 6205. In some embodiments, a lesson success is evaluated by the adaptive teaching system 6215 indicating how successful a lesson was in instructing the student on the topic associated with the lesson. In some embodiments, student engagement information based on a student's engagement with the lesson may be applied to the artificial intelligence model and the artificial intelligence model may output a lesson success evaluation indicating, in part, an indication of how successful the lesson was in teaching the student. When the student has been evaluated, the routine 6300 moves to block 6330.

At block 6330, the adaptive teaching system 6215 adjusts the lesson plan to create an adjusted lesson plan. The lesson plan may be adjusted based on, for example, the result of the evaluation of the student performed at block 6325, a request from the teacher 6260, a request from the student 6205, or based on another determination made by the adaptive teaching system 6215. The adaptive teaching system 6215 adjusts the lesson plan to more efficiently or effectively teach the student 6205, for example by determining that the student finds a particular color or object distracting, or is more engaged by a particular teacher 6260 or object as described previously herein. Adjusting the lesson plan may comprise adding videos or tests, removing videos or tests, reordering videos or tests, or otherwise altering the previous lesson plan. In some embodiments, the adaptive teaching system 6215 may determine a time for instruction is nearing completion (e.g., when one hour is set aside for instruction and 58 minutes have passed) or has been completed, and may adjust the lesson plan to end by removing any remaining lessons from the lesson plan. As discussed above in relation to block 6315, a teacher may be asked to provide one or more video segments to create a video for a new lesson. The request for the teacher to record one or more video segments may be sent at block 6330 in response to the evaluation of block 6325 indicating a new lesson should be created. When the lesson plan has been adjusted the routine 6300 moves to decision block 6335.

At decision block 6335, the adaptive teaching system 6215 determines whether there are additional lessons to be completed in the lesson plan. Lessons may comprise video lessons, audio lessons, text lessons, or testing material. When the adaptive teaching system 6215 determines there are additional lessons in the lesson plan to be completed, the routine 6300 moves to block 6320 and transmits the next lesson in the lesson plan. When the adaptive teaching system 6215 determines there are no more lessons for the student 6205 to complete at this time, the routine 6300 moves to block 6340 and ends.

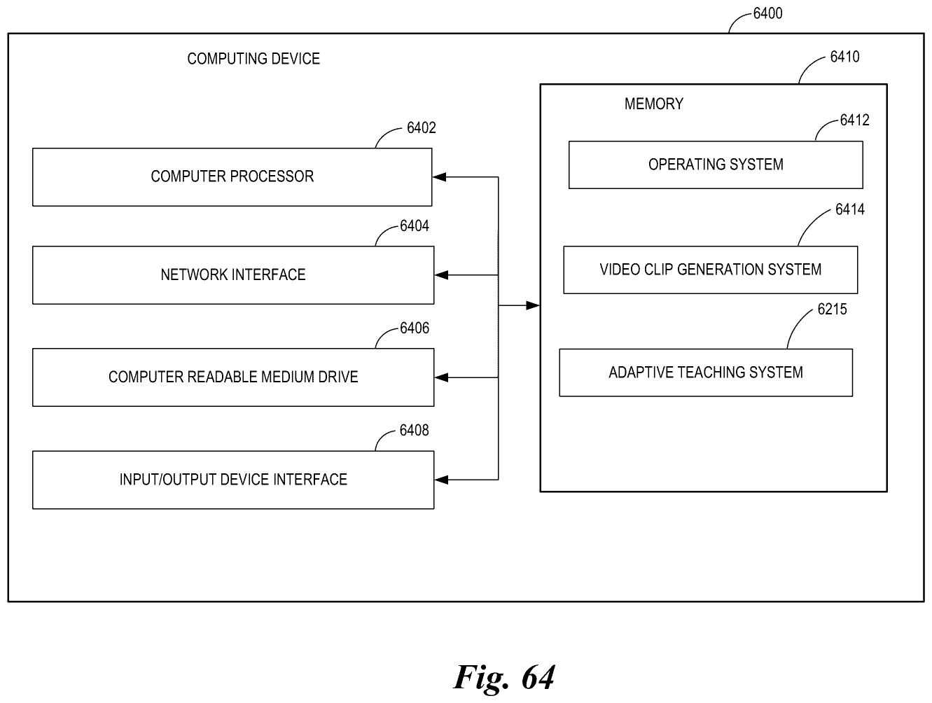

FIG. 64 depicts a block diagram of an example computing device 6400 configured to implement the various functionality described herein, for example the student device 6210, server 6220, or the teacher device 6250.

In some examples, the features and services provided by the computing device 6400 may be implemented as web services consumable via one or more communication networks. In further embodiments, the computing device 6400 is provided by one or more virtual machines implemented in a hosted computing environment. The hosted computing environment may include one or more rapidly provisioned and released computing resources, such as computing devices, networking devices, and/or storage devices. A hosted computing environment may also be referred to as a “cloud” computing environment.

In some embodiments, as shown, a communication device 110A may include: one or more computer processors 6402, such as physical central processing units (“CPUs”); one or more network interfaces 6404, such as a network interface cards (“NICs”); one or more computer readable medium drives 6406, such as a high density disk (“HDDs”), solid state drives (“SSDs”), flash drives, and/or other persistent non-transitory computer readable media; one or more input/output device interfaces 6408, such as a display, a speaker, a microphone, a camera, and/or other components configured to allow the input or output of information; and one or more computer-readable memories 6410, such as random access memory (“RAM”) and/or other volatile non-transitory computer readable media.

The computer-readable memory 6410 may include computer program instructions that one or more computer processors 6402 execute and/or data that the one or more computer processors 6402 use in order to implement one or more embodiments. For example, the computer-readable memory 6410 can store an operating system 6412 to provide general administration of the computing device 6400. As another example, the computer-readable memory 6410 may store a video clip generation system 6414 configured to enable the recording, editing, processing, and display of videos used by the system described herein to create lesson video clips. In some examples, a video lesson is received from the server 6220 by the one or more network interfaces 6404 based on an input of the owner or user of the computing device 6400 (e.g., a student, teacher, or other like individual). In other examples, the video lesson or clip may be stored in the computer-readable memory 6410 of the computing device 6400 for as long as a user owns or controls the computing device 6400 (e.g., until the computing device 6400 is transferred to another user).

As another example, the computer-readable memory 6410 may store an adaptive teaching system 6215. The adaptive teaching system 6215 may be received from the server 6220 by the one or more network interfaces 6404 of the computing device 6400. Alternatively, the adaptive teaching system 6215 may be stored in the computer-readable memory 6410 of the computing device 6400, such as when installed by a user (e.g., the student 6205). The adaptive teaching system 6215 stored in the computer-readable memory 6410 may differ from a second adaptive teaching system 6215 that would be used by a second computing device 6400, for example the adaptive teaching system 6215 installed on the student device 6210 may provide functionality associated with instructing the student 6205 and the adaptive teaching system 6215 installed on the teacher device 6250 may provide functionality associated with recording video lessons by the teacher 6260.

### Terminology

All of the methods and tasks described herein may be performed and fully automated by a computer system. The computer system may, in some cases, include multiple distinct computers or computing devices (e.g., physical servers, workstations, storage arrays, cloud computing resources, etc.) that communicate and interoperate over a network to perform the described functions. Each such computing device typically includes a processor (or multiple processors) that executes program instructions or modules stored in a memory or other non-transitory computer-readable storage medium or device (e.g., solid state storage devices, disk drives, etc.). The various functions disclosed herein may be embodied in such program instructions, or may be implemented in application-specific circuitry (e.g., ASICs or FPGAs) of the computer system. Where the computer system includes multiple computing devices, these devices may, but need not, be co-located. The results of the disclosed methods and tasks may be persistently stored by transforming physical storage devices, such as solid-state memory chips or magnetic disks, into a different state. In some embodiments, the computer system may be a cloud-based computing system whose processing resources are shared by multiple distinct business entities or other users.

Depending on the embodiment, certain acts, events, or functions of any of the processes or algorithms described herein can be performed in a different sequence, can be added, merged, or left out altogether (e.g., not all described operations or events are necessary for the practice of the algorithm). Moreover, in certain embodiments, operations or events can be performed concurrently, e.g., through multi-threaded processing, interrupt processing, or multiple processors or processor cores or on other parallel architectures, rather than sequentially.

The various illustrative logical blocks, modules, routines, and algorithm steps described in connection with the embodiments disclosed herein can be implemented as electronic hardware, or combinations of electronic hardware and computer software. To clearly illustrate this interchangeability, various illustrative components, blocks, modules, and steps have been described above generally in terms of their functionality. Whether such functionality is implemented as hardware, or as software that runs on hardware, depends upon the particular application and design conditions imposed on the overall system. The described functionality can be implemented in varying ways for each particular application, but such implementation decisions should not be interpreted as causing a departure from the scope of the disclosure.

Moreover, the various illustrative logical blocks and modules described in connection with the embodiments disclosed herein can be implemented or performed by a machine, such as a processor device, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A processor device can be a microprocessor, but in the alternative, the processor device can be a controller, microcontroller, or state machine, combinations of the same, or the like. A processor device can include electrical circuitry configured to process computer-executable instructions. In another embodiment, a processor device includes an FPGA or other programmable device that performs logic operations without processing computer-executable instructions. A processor device can also be implemented as a combination of computing devices, e.g., a combination of a DSP and a microprocessor, a plurality of microprocessors, one or more microprocessors in conjunction with a DSP core, or any other such configuration. Although described herein primarily with respect to digital technology, a processor device may also include primarily analog components. For example, some or all of the algorithms described herein may be implemented in analog circuitry or mixed analog and digital circuitry. A computing environment can include any type of computer system, including, but not limited to, a computer system based on a microprocessor, a mainframe computer, a digital signal processor, a portable computing device, a device controller, or a computational engine within an appliance, to name a few.

The elements of a method, process, routine, or algorithm described in connection with the embodiments disclosed herein can be embodied directly in hardware, in a software module executed by a processor device, or in a combination of the two. A software module can reside in RAM memory, flash memory, ROM memory, EPROM memory, EEPROM memory, registers, hard disk, a removable disk, a CD-ROM, or any other form of a non-transitory computer-readable storage medium. An exemplary storage medium can be coupled to the processor device such that the processor device can read information from, and write information to, the storage medium. In the alternative, the storage medium can be integral to the processor device. The processor device and the storage medium can reside in an ASIC. The ASIC can reside in a user terminal. In the alternative, the processor device and the storage medium can reside as discrete components in a user terminal.

Conditional language used herein, such as, among others, “can,” “could,” “might,” “may,” “e.g.,” and the like, unless specifically stated otherwise, or otherwise understood within the context as used, is generally intended to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without other input or prompting, whether these features, elements and/or steps are included or are to be performed in any particular embodiment. The terms “comprising,” “including,” “having,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list.

Disjunctive language such as the phrase “at least one of X, Y, Z,” unless specifically stated otherwise, is otherwise understood with the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present.

Unless otherwise explicitly stated, articles such as “a” or “an” should generally be interpreted to include one or more described items. Accordingly, phrases such as “a device configured to” are intended to include one or more recited devices. Such one or more recited devices can also be collectively configured to carry out the stated recitations. For example, “a processor configured to carry out recitations A, B and C” can include a first processor configured to carry out recitation A working in conjunction with a second processor configured to carry out recitations B and C.

While the above detailed description has shown, described, and pointed out novel features as applied to various embodiments, it can be understood that various omissions, substitutions, and changes in the form and details of the devices or algorithms illustrated can be made without departing from the spirit of the disclosure. As can be recognized, certain embodiments described herein can be embodied within a form that does not provide all of the features and benefits set forth herein, as some features can be used or practiced separately from others. The scope of certain embodiments disclosed herein is indicated by the appended claims rather than by the foregoing description. All changes which come within the meaning and range of equivalency of the claims are to be embraced within their scope.

What is claimed is:

1. A method comprising:
receiving lesson information comprising a plurality of lessons;
receiving student information associated with a student;
preparing a lesson plan based in part on the lesson information and the student information;
presenting a first lesson of the plurality of lessons to the student;
determining, based on an interaction between the student and the first lesson, a student engagement information;
applying the student engagement information as input to a machine learning model, wherein applying the student engagement information to the machine learning model causes the machine learning model to output a lesson success evaluation;
determining a lesson success based on the lesson success evaluation;
modifying the lesson plan based on the lesson success to generate an adjusted lesson plan; and
presenting a second lesson of the plurality of lessons to the student based on the adjusted lesson plan.

2. The method of claim 1, wherein the lesson information further comprises a lesson level associated with a difficulty of the plurality of lessons.

3. The method of claim 1, further comprising:
transmitting a request to record a video to a teacher;
receiving the video from the teacher;
generating a lesson based in part on the received video to create a new lesson; and
adding the new lesson to the plurality of lessons.

4. The method of claim 3, wherein the request is transmitted in response to the determination of the lesson success.

5. The method of claim 3, further comprising:
applying the lesson plan as input to a machine learning model, wherein application of the lesson plan to the machine learning model causes the machine learning model to output first information;
comparing the first information to the plurality of lessons; and
determining, based on the comparison of the first information to the plurality of lessons, the first information is not contained in the plurality of lessons, wherein the new lesson comprises the first information.

6. The method of claim 3, wherein transmitting a request further comprises:
applying a third lesson to the machine learning model, wherein application of the third lesson to the machine learning model causes the machine learning model to output a lesson completeness; and
determining the third lesson is an incomplete lesson based on the lesson completeness.

7. The method of claim 3, further comprising:
applying a third lesson to the machine learning model, wherein application of the third lesson to the machine learning model causes the machine learning model to output an incorrect lesson element; and
determining the third lesson is an incorrect lesson based on the incorrect lesson element, wherein the incorrect lesson is not suitable for presentation to the student.

8. The method of claim 7, wherein the incorrect lesson element is one of a position of a teacher, an extraneous sensory stimuli, or an incorrect information item.

9. The method of claim 1, further comprising:
presenting to a teacher a prompt, the prompt requesting the teacher record the first lesson;
displaying to the teacher one or more instructions, the instructions indicating a set of recommendations for recording a first video segment;
receiving, from the teacher, a start indication indicating a request to start recording the first video segment;
presenting, to the teacher, a video recording interface comprising a position indicator indicating a head position in a video frame, a body position indicator indicating a body position in the video frame, and instructions;
recording the first video segment;
receiving from the teacher a stop indication indicating the teacher has completed recording the first video segment;
terminating recording the first video segment;
presenting to the teacher an editing interface comprising a trim option, the trim option allowing the teacher to edit at least a portion of the first video;
receiving from the teacher a completion indication indicating the teacher has completed editing the first video segment; and
combining the first video segment with a second video segment wherein the first video segment and the second video segment are associated with a topic of the first lesson to generate the first lesson.

10. A system comprising:
a memory storing computer-executable instruction; and
a processor in communication with the memory, wherein the computer-executable instructions, when executed by the processor, cause the processor to:
receive lesson information comprising a plurality of lessons;
receive student information associated with a student;
prepare a lesson plan based in part on the lesson information and the student information;
present a first lesson of the plurality of lessons to the student;
determine, based on an interaction between the student and the first lesson, a student engagement information;
apply the student engagement information as input to a machine learning model, wherein applying the student engagement information to the machine learning model causes the machine learning model to output a lesson success evaluation;
determine a lesson success based on the lesson success evaluation;
modify the lesson plan based on the lesson success to generate an adjusted lesson plan; and
present a second lesson of the plurality of lessons to the student based on the adjusted lesson plan.

11. The system of claim 10, wherein the lesson information further comprises a lesson level associated with a difficulty of the plurality of lessons.

12. The system of claim 10, wherein the computer-executable instructions, when executed by the processor, further cause the processor to:
transmit a request to record a video to a teacher;
receive the video from the teacher;
generate a lesson based in part on the received video to create a new lesson; and
add the new lesson to the plurality of lessons.

13. The system of claim 12, wherein the computer-executable instructions, when executed by the processor, further cause the processor to:
apply the lesson plan as input to a machine learning model, wherein application of the lesson plan to the machine learning model causes the machine learning model to output a first information;
compare the first information to the plurality of lessons; and
determine, based on the comparison of the first information to the plurality of lessons, the first information is not contained in the plurality of lessons, wherein the new lesson comprises the first information.

14. The system of claim 12, wherein the computer-executable instructions, when executed by the processor, further cause the processor to:
apply a third lesson to the machine learning model, wherein application of the third lesson to the machine learning model causes the machine learning model to output a lesson completeness; and
determine the third lesson is an incomplete lesson based on the lesson completeness.

15. The system of claim 12, where the computer-executable instructions, when executed by the processor, further cause the processor to:
apply a third lesson to the machine learning model, wherein application of the third lesson to the machine learning model causes the machine learning model to output an incorrect lesson element; and
determine the third lesson is an incorrect lesson based on the incorrect lesson element, wherein the incorrect lesson is not suitable for presentation to the student.

16. The system of claim 10, where the computer-executable instructions, when executed by the processor, further cause the processor to:
present to a teacher a prompt, the prompt requesting the teacher record the first lesson;
display to the teacher one or more instructions, the instructions indicating a set of recommendations for recording a first video segment;
receive, from the teacher, a start indication indicating a request to start recording the first video segment;
present, to the teacher, a video recording interface comprising a position indicator indicating a head position in a video frame, a body position indicator indicating a body position in the video frame, and instructions;
record the first video segment;
receive from the teacher a stop indication indicating the teacher has completed recording the first video segment;
terminate recording the first video segment;
present to the teacher an editing interface comprising a trim option, the trim option allowing the teacher to edit at least a portion of the first video;
receive from the teacher a completion indication indicating the teacher has completed editing the first video segment; and
combine the first video segment with a second video segment wherein the first video segment and the second video segment are associated with a topic of the first lesson to generate the first lesson.

17. The system of claim 16, wherein the video recording interface further comprises a recording status indicator.

18. The system of claim 16, wherein the instructions comprise one of a script or a pronunciation.

19. A non-transitory computer-readable storage medium comprising computer-executable instructions, wherein the computer-executable instructions, when executed by a computer system, cause the computer system to:
receive, at a computing device having a processor and a memory, lesson information comprising a plurality of lessons;
receive, at the computing device, student information associated with a student;
prepare a lesson plan based in part on the lesson information and the student information;
present, by a display of the computing device, a first lesson of the plurality of lessons to the student;
determine, based on an interaction between the student and the first lesson, a student engagement information;
apply the student engagement information as input to a machine learning model, wherein applying the student engagement information to the machine learning model causes the machine learning model to output a lesson success evaluation;
determine a lesson success based on the lesson success evaluation;
modify the lesson plan based on the lesson success to generate an adjusted lesson plan; and
present, by the display of the computing device, a second lesson of the plurality of lessons to the student based on the adjusted lesson plan.

20. The non-transitory machine-readable storage medium of claim 19, wherein the computer-executable instructions, when executed, further cause the computer system to:
transmit a request to record a video to a teacher;
present to a teacher a prompt, the prompt requesting the teacher record the first lesson;
display to the teacher one or more instructions, the instructions indicating a set of recommendations for recording a first video segment;
receive, from the teacher, a start indication indicating a request to start recording the first video segment;
present, to the teacher, a video recording interface comprising a position indicator indicating a head position in a video frame, a body position indicator indicating a body position in the video frame, and instructions;
record the first video segment;
receive from the teacher a stop indication indicating the teacher has completed recording the first video segment;
terminate recording the first video segment;
present to the teacher an editing interface comprising a trim option, the trim option allowing the teacher to edit at least a portion of the first video;
receive from the teacher a completion indication indicating the teacher has completed editing the first video segment; and
combine the first video segment with a second video segment wherein the first video segment and the second video segment are associated with a topic of the first lesson to generate the first lesson.
